(19) United States
(12) Patent Application Publication
(10) Pub. No.: US 2026/0370340 A1
(43) Pub. Date: Nov. 19, 2026

(54) APPARATUS AND METHOD FOR TRANSMITTING AND RECEIVING SIGNAL GENERATED BY USING DOWN CONVERSION IN WIRELESS COMMUNICATION SYSTEM

(71) Applicant: LG ELECTRONICS INC., Seoul (KR)

(72) Inventors: Kukheon CHOI, Seoul (KR); Kangjae JUNG, Seoul (KR); Soyeon LEE, Seoul (KR); Dongjin KIM, Seoul (KR)

(73) Assignee: LG ELECTRONICS INC., Seoul (KR)

(21) Appl. No.: 19/145,635

(22) PCT Filed: Jan. 5, 2024
(86) PCT No.: PCT/KR2024/000243

§ 371 Date: Jul. 3, 2025

Related U.S. Application Data
(60) Provisional application No. 63/437,630, filed on Jan. 6, 2023.

(51) Int. Cl. H04B 10/61; H04L 5/00

(52) U.S. Cl. CPC H04B 10/612; H04L 5/0007; H04L 5/0098

(57) ABSTRACT

The purpose of the present disclosure is to transmit and receive a signal generated by using down conversion in a wireless communication system. An operation method of a first device comprises the steps of: determining a configuration for a frame structure including at least one of at least one chunk, a first frequency gap between the at least one chunk, and at least one sub-chunk included in the at least one chunk; generating at least one first signal by down-converting at least one optical signal corresponding to the at least one chunk; and on the basis of the configuration, transmitting the at least one first signal by using the at least one chunk arranged in a first frame, wherein a second frequency gap between the at least one sub-chunk may be determined on the basis of phase noise.

### CROSS-REFERENCE TO RELATED APPLICATIONS

This application is the National Stage filing under 35 U.S.C. 371 of International Application No. PCT/KR2024/000243, filed on Jan. 5, 2024, which claims the benefit of U.S. Provisional Application No. 63/437,630, filed on Jan. 6, 2023, the contents of which are all hereby incorporated by reference herein in their entireties.

### TECHNICAL FIELD

The following description is directed to a wireless communication system, and includes devices and methods for transmitting and receiving signals generated using down conversion in a wireless communication system.

### BACKGROUND

Wireless communication systems have been widely deployed to provide various types of communication services including voice and data services. In general, a wireless communication system is a multiple access system that supports communication among multiple users by sharing available system resources (e.g. bandwidth, transmit power, etc.) among the multiple users. The multiple access system may adopt a multiple access scheme such as code division multiple access (CDMA), frequency division multiple access (FDMA), time division multiple access (TDMA), orthogonal frequency division multiple access (OFDMA), or single carrier frequency division multiple access (SC-FDMA).

Especially, as many communication devices have demanded large communication capacity, enhanced mobile broadband (eMBB) communication technology has been proposed compared to conventional radio access technology (RAT). In addition, communication systems that consider reliability and latency sensitive services/user equipment (UE) as well as massive machine type communications (mMTC) that connect multiple devices and objects to provide various services anytime, anywhere are being proposed. Various technical configurations have been proposed for this purpose.

### SUMMARY

The present disclosure is directed to devices and methods for effectively transmitting and receiving signals generated using down conversion in a wireless communication system.

The present disclosure is directed to devices and methods for generating a signal in a target band using down conversion in a wireless communication system.

The present disclosure is directed to devices and methods for transmitting and receiving signals based on a frame structure for down conversion numerology in a wireless communication system.

This disclosure is directed to devices and methods for using a frame structure based on chunk and sub-chunk for down conversion numerology in wireless communication system.

This disclosure is directed to a device and method for performing down conversion by inputting a single chunk to a single optical to electrical converter in a wireless communication system.

The disclosure is directed to a device and method for configuring frequency gap between chunks or sub-chunks in a wireless communication system.

The disclosure is directed to a device and method for a hybrid transceiver that uses both down conversion numerology and up conversion numerology frame structures in a wireless communication system.

The disclosure is directed to a device and method for determining the frame structure of a primary cell and a secondary cell in a wireless communication system.

The disclosure is directed to a device and method for applying differential phase shift keying (DPSK) modulation in a frame structure for down conversion numerology in a wireless communication system.

The disclosure is directed to a device and method for transmitting and receiving signals using initial symbols and differential symbols in a wireless communication system.

The disclosure is directed to a device and method for mapping differential symbols to initial symbols in a wireless communication system.

The disclosure is directed to a device and method for mapping differential symbols to unsynchronized initial symbols in a wireless communication system.

The technical objectives of the present disclosure are not limited to those mentioned above, and other technical problems not mentioned may be considered by one of ordinary skill in the art to which the technical configurations of the present disclosure are applied from the embodiments of the present disclosure that will be described below.

According to an embodiment of the present disclosure, a method performed by a first device in wireless communication system may comprise: determining a configuration for a frame structure including at least one of at least one chunk, a first frequency gap between the at least one chunk, at least one sub-chunk included in the at least one chunk; generating at least one first signal by down conversing at least one optical signal corresponding to the at least one chunk; and transmitting the at least one first signal by using the at least one chunk mapped to a first frame, based on the configuration, wherein a second frequency gap between the at least one sub-chunk may be determined based on a phase noise.

According to an embodiment of the present disclosure, a method performed by a second device in wireless communication system may comprise: determining a configuration related to at least one chunk, a first frequency gap between the at least one chunk, and at least one sub-chunk included in the at least one chunk; determining the at least one chunk mapped to a first frame based on the configuration; and obtaining data based on at least one first signal received through the at least one chunk, wherein a second frequency gap between the at least one sub-chunk may be determined based on phase noise.

According to an embodiment of the present disclosure, a first device in wireless communication system may comprise: a transceiver; and a processor connected to the transceiver, wherein the processor may control to: determine a configuration for a frame structure including at least one of at least one chunk, a first frequency gap between the at least one chunk, at least one sub-chunk included in the at least one chunk; generate at least one first signal by down conversing at least one optical signal corresponding to the at least one chunk; and transmit the at least one first signal by using the at least one chunk mapped to a first frame, based on the configuration, wherein a second frequency gap between the at least one sub-chunk may be determined based on a phase noise.

According to an embodiment of the present disclosure, a second device in wireless communication system may comprise: a transceiver; and a processor connected to the transceiver, wherein the processor may control to: determine a configuration related to at least one chunk, a first frequency gap between the at least one chunk, and at least one sub-chunk included in the at least one chunk; determine the at least one chunk mapped to a first frame based on the configuration; and obtain data based on at least one first signal received through the at least one chunk, wherein a second frequency gap between the at least one sub-chunk may be determined based on phase noise.

According to an embodiment of the present disclosure, a communication device may comprise: at least one processor; at least one computer memory, connected to the at least one processor, storing instructions that instruct instructions according to being executed by the at least one processor, wherein the operations may comprise: determining a configuration for a frame structure including at least one of at least one chunk, a first frequency gap between the at least one chunk, at least one sub-chunk included in the at least one chunk; generating at least one first signal by down conversing at least one optical signal corresponding to the at least one chunk; and transmitting the at least one first signal by using the at least one chunk mapped to a first frame, based on the configuration, wherein a second frequency gap between the at least one sub-chunk may be determined based on a phase noise.

According to an embodiment of the present disclosure, a non-transitory computer-readable medium storing at least one instruction may comprise: the at least one instruction executable by a processor, wherein the at least one instruction may control a device to: determine a configuration for a frame structure including at least one of at least one chunk, a first frequency gap between the at least one chunk, at least one sub-chunk included in the at least one chunk; generate at least one first signal by down conversing at least one optical signal corresponding to the at least one chunk; and transmit the at least one first signal by using the at least one chunk mapped to a first frame, based on the configuration, wherein a second frequency gap between the at least one sub-chunk may be determined based on a phase noise.

The above-described features of the present disclosure are only some of the preferred embodiments of the present disclosure, and various embodiments reflecting the technical features of the present disclosure may be derived and understood by one with ordinary skill in the art based on the detailed description of the present disclosure that follows.

Embodiments based on the present disclosure may have the following effects.

According to the disclosure, a wireless signal generated by down conversion in a wireless communication system may be transmitted efficiently.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings. That is, unintended effects of the present disclosure may be also derived by those skilled in the art from the embodiments of the present disclosure.

### BRIEF DESCRIPTION OF THE DRAWINGS

The accompanying drawings are intended to provide a better understanding of the present disclosure and may provide embodiments of the disclosure along with a detailed description. However, the technical features of the present disclosure are not limited to any specific drawing, and the features disclosed in each drawing may be combined with each other to form new embodiments. Reference numerals in each drawing may refer to structural elements.

FIG. 1 shows an example communication system applicable to the present disclosure.

FIG. 2 shows an example of a wireless device applicable to the present disclosure.

FIG. 3 shows an example of a transmitter structure using a photon source according to an embodiment of the disclosure.

FIG. 4 shows an example of the structure of an optical modulator according to an embodiment of the disclosure.

FIG. 5 shows an example of the operation of an optical to electrical converter (O/E converter) according to an embodiment of the disclosure.

FIG. 6 shows an example of a graph illustrating RF phase according to input power according to an embodiment of the present disclosure.

FIG. 7 shows an example of phase noise according to the optical power level around a radio frequency carrier of 10 GHz according to an embodiment of the present disclosure.

FIG. 8 shows an example of a Kerr signal according to an embodiment of the present disclosure.

FIG. 9 shows an example of a structure of a photonic source based THz transmitter to which DQPSK is applied according to an embodiment of the present disclosure.

FIG. 10 shows an example of a structure of a THz heterodyne receiver according to an embodiment of the present disclosure.

FIG. 11 shows an example of an available band up to 1 terahertz considering signal attenuation according to an embodiment of the present disclosure.

FIG. 12 shows an example of a model of a terahertz band communication system according to an embodiment of the present disclosure.

FIG. 13 shows an example of a terahertz pulse according to an embodiment of the present disclosure.

FIG. 14 shows an example of the relationship between the medium form and modulation in an optical to electrical converter according to an embodiment of the present disclosure.

FIG. 15 shows an example of a frame structure for a terahertz multi-carrier system according to an embodiment of the present disclosure.

FIG. 16 shows an example of a structure of a photon source-based terahertz transmitter according to an embodiment of the present disclosure.

FIG. 17 shows an example of multiple frequency band chunks being transmitted by combining them using a single optical to electrical converter according to an embodiment of the present disclosure.

FIG. 18 shows an example of a frame structure for reducing phase error values between chunks or sub-chunks according to an embodiment of the present disclosure.

FIG. 19 shows an example of a procedure for transmitting a wireless signal using down conversion according to an embodiment of the present disclosure.

FIG. 20 shows an example of a procedure for receiving a wireless signal using down conversion according to an embodiment of the present disclosure.

FIGS. 21a to 21f show examples of frame structures according to the present disclosure.

FIG. 22 shows an example of a change in the frame structure based on a time division duplexing (TDD) method according to an embodiment of the present disclosure.

FIG. 23 shows an example of a frame structure changed according to an embodiment of the present disclosure.

FIG. 24 shows another example of a frame structure changed according to an embodiment of the present disclosure.

FIG. 25 shows another example of a frame structure changed according to an embodiment of the present disclosure.

FIG. 26 shows an example in which the frame structure is changed without readjustment time according to an embodiment of the present disclosure.

FIG. 27 shows an example of a procedure for transmitting symbols based on differential phase shift keying (DPSK) modulation according to an embodiment of the present disclosure.

FIG. 28 shows an example of a procedure for receiving symbols based on DPSK modulation according to an embodiment of the present disclosure.

FIG. 29 shows an example of mapping initial symbols and differential symbols based on DPSK modulation according to an embodiment of the present disclosure.

FIG. 30 shows a different mapping example of initial symbols and differential symbols based on DPSK modulation according to an embodiment of the present disclosure.

FIG. 31 shows an example of a procedure for mapping initial symbols and differential symbols received at different time intervals according to an embodiment of the present disclosure.

### DETAILED DESCRIPTION

The embodiments of the present disclosure described hereinbelow are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or features of any one embodiment may be included in another embodiment and may be replaced with corresponding constructions or features of another embodiment.

In the description of the attached drawings, a detailed description of known procedures or steps of the present disclosure will be avoided lest it should obscure the subject matter of the present disclosure. In addition, procedures or steps that could be understood to those skilled in the art will not be described either.

Throughout the specification, whenever any part is the to “comprising or including” any component, it is meant to be inclusive of other components, not exclusive of other components, unless specifically stated to the contrary. In addition, terms such as “ . . . part,” “ . . . device,” “module,” and the like in the specification mean a unit that performs at least one function or operation, which may be implemented in hardware or software or a combination of hardware and software. In addition, the terms “a or an,” “one,” “the,” and similar related words may be used in the context of describing this disclosure (especially in the context of the following claims) to include both the singular and the plural, unless otherwise indicated herein or clearly refuted by the context.

In the embodiments of the present disclosure, a description is made, centering on a data transmission and reception relationship between a Base Station (BS) and a User Equipment (UE). A BS is a terminal node of a network, which communicates directly with a UE. In some cases, a specific operation described as performed by the BS may be performed by an upper node of the BS.

Namely, it is apparent that, in a network comprised of a plurality of network nodes including a BS, various operations performed for communication with a UE may be performed by the BS or network nodes other than the BS. The term ‘BS’ may be replaced with the term ‘fixed station’, ‘Node B’, ‘evolved Node B (eNode B or eNB)’, Advanced BS (ABS)’, ‘Access Point (AP)’, etc.

In addition, the term ‘terminal’ may be replaced with the term ‘UE’, ‘Mobile Station (MS)’, ‘Subscriber Station (SS)’, ‘Mobile Subscriber Station (MSS)’, ‘Mobile Terminal’, ‘Advanced MS (AMS)’, etc.

A transmission end refers to a fixed and/or mobile node that provides data service or voice service and a reception end refers to a fixed and/or mobile node that receives data service or voice service. Accordingly, a UE may serve as a transmission end and a BS may serve as a reception end, on the uplink, whereas the UE may serve as a reception end and the BS may serve as a transmission end, on the downlink.

The embodiments of the present disclosure can be supported by standard documents disclosed for at least one of wireless access systems, that is, an Institute of Electrical and Electronics Engineers (IEEE) 802.xx system, a 3rd Generation Partnership Project (3GPP) system, a 3GPP Long Term Evolution (LTE) system, and a 3GPP2 system. Especially, the embodiments of the present disclosure can be supported by 3GPP TS 38.211, 3GPP TS 38.212, 3GPP TS 38.213, and 3GPP TS 38.321.

Further, embodiments of the present disclosure may be applicable to other wireless access systems and are not limited to the systems described above. For example, they may be applicable to post-3GPP 5G NR systems, and are not limited to any specific system.

That is, steps or parts that are not described in order to clarify the subject matter of the present disclosure can be supported by the above documents. Further, all terms described in this specification can be explained by the standard documents.

Reference will now be made in detail to the preferred embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

Specific terms used in the embodiments of the present disclosure are used to help the understanding of the present disclosure and they can be replaced with other terms within the spirit and scope of the present disclosure.

The following embodiments of the present disclosure can be applied to a variety of wireless access technologies, for example, CDMA, FDMA, TDMA, OFDMA, SC-FDMA, MC-FDMA, and the like.

For clarity, the following description is based on 3GPP communication systems (e.g., LTE, NR, etc.), but the technical ideas of the present disclosure are not limited thereto. LTE may refer to technology from 3GPP TS 36.xxx Release 8 onwards. More specifically, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology from TS Release 17 and/or Release 18 onwards. “xxx” means standard document detail number. LTE/NR/6G may be referred to collectively as the 3GPP system.

For background descriptions, terms, abbreviations, and the like used in this disclosure, reference is made to standards documents published prior to this disclosure. For example, the 36.xxx and 38.xxx standards documents may be referenced.

### Communication System Applicable to the Present Disclosure

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

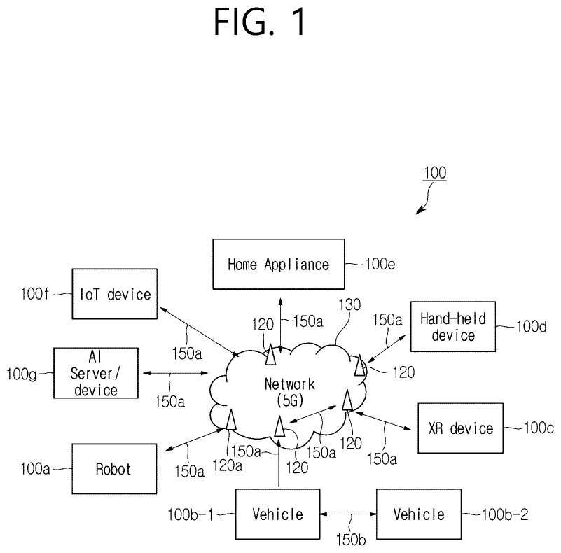

FIG. 1 shows a communication system applied to the present disclosure.

Referring to FIG. 1, a communication system 100 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 100g. For example, the vehicles 100b-1, 100b-2 may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device 100d may include a smartphone, a smartpad, a wearable device (e.g., a smartwatch or a smartglasses), and a computer (e.g., a notebook). The home appliance 100e may include a TV, a refrigerator, and a washing machine. The IoT device 100f may include a sensor and a smartmeter. For example, the BSs 120 and the network 130 may be implemented as wireless devices and a specific wireless device 120a may operate as a BS/network node with respect to other wireless devices.

The wireless devices 100a to 100f may be connected to the network 120 via the BSs 120. An AI technology may be applied to the wireless devices 100a to 100f and the wireless devices 100a to 100f may be connected to the AI server 100g via the network 130. The network 130 may be configured using a 3G network, a 4G (e.g., LTE) network, or a 5G (e.g., NR) network. Although the wireless devices 100a to 100f may communicate with each other through the BSs 120/network 130, the wireless devices 100a to 100f may perform direct communication (e.g., sidelink communication) with each other without passing through the BSs 120/network 130. For example, the vehicles 100b-1 and 100b-2 may perform direct communication (e.g. Vehicle-to-Vehicle (V2V)/Vehicle-to-everything (V2X) communication). The IoT device 100f (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 120, or BS 120/BS 120. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

### Communication System Applicable to the Present Disclosure

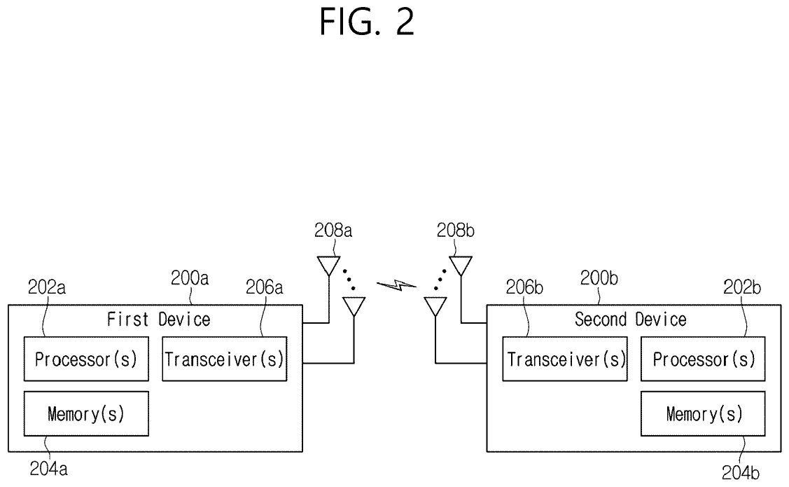

FIG. 2 is a diagram showing an example wireless device that may be applicable to the present disclosure.

Referring to FIG. 2, a first wireless device 200a and a second wireless device 200b may transmit radio signals through a variety of RATs (e.g., LTE and NR). Herein, {the first wireless device 200a and the second wireless device 200b} may correspond to {the wireless device 100x and the BS 120} and/or {the wireless device 100x and the wireless device 100x} of FIG. 1.

The first wireless device 200a may include one or more processors 202a and one or more memories 204a and additionally further include one or more transceivers 206a and/or one or more antennas 208a. The processor(s) 202a may control the memory(s) 204a and/or the transceiver(s) 206a and may be configured to implement the descriptions, functions, procedures, proposals, methods, and/or operational flowcharts disclosed in this document. For example, the processor(s) 202a may process information within the memory(s) 204a to generate first information/signals and then transmit radio signals including the first information/signals through the transceiver(s) 206a. The processor(s) 202a may receive radio signals including second information/signals through the transceiver 206a and then store information obtained by processing the second information/signals in the memory(s) 204a. The memory(s) 204a may be connected to the processor(s) 202a and may store a variety of information related to operations of the processor(s) 202a. For example, the memory(s) 204a may store software code including commands for performing a part or the entirety of processes controlled by the processor(s) 202a or for performing the descriptions, functions, procedures, proposals, methods, and/or operational flowcharts disclosed in this document. Herein, the processor(s) 202a and the memory(s) 204a may be a part of a communication modem/circuit/chip designed to implement RAT (e.g., LTE or NR). The transceiver(s) 206a may be connected to the processor(s) 202a and transmit and/or receive radio signals through one or more antennas 208a. Each of the transceiver(s) 206a may include a transmitter and/or a receiver. The transceiver(s) 206a may be interchangeably used with Radio Frequency (RF) unit(s). In the present disclosure, the wireless device may represent a communication modem/circuit/chip.

The second wireless device 200b may include one or more processors 202b and one or more memories 204b and additionally further include one or more transceivers 206b and/or one or more antennas 208b. The processor(s) 202b may control the memory(s) 204b and/or the transceiver(s) 206b and may be configured to implement the descriptions, functions, procedures, proposals, methods, and/or operational flowcharts disclosed in this document. For example, the processor(s) 202b may process information within the memory(s) 204b to generate third information/signals and then transmit radio signals including the third information/signals through the transceiver(s) 206b. The processor(s) 202b may receive radio signals including fourth information/signals through the transceiver(s) 206b and then store information obtained by processing the fourth information/signals in the memory(s) 204b. The memory(s) 204b may be connected to the processor(s) 202b and may store a variety of information related to operations of the processor(s) 202b. For example, the memory(s) 204b may store software code including commands for performing a part or the entirety of processes controlled by the processor(s) 202b or for performing the descriptions, functions, procedures, proposals, methods, and/or operational flowcharts disclosed in this document. Herein, the processor(s) 202b and the memory(s) 204b may be a part of a communication modem/circuit/chip designed to implement RAT (e.g., LTE or NR). The transceiver(s) 206b may be connected to the processor(s) 202b and transmit and/or receive radio signals through one or more antennas 208b. Each of the transceiver(s) 206b may include a transmitter and/or a receiver. The transceiver(s) 206b may be interchangeably used with RF unit(s). In the present disclosure, the wireless device may represent a communication modem/circuit/chip.

Hereinafter, hardware elements of the wireless devices 200a and 200b will be described more specifically. One or more protocol layers may be implemented by, without being limited to, one or more processors 202a and 202b. For example, the one or more processors 202a and 202b may implement one or more layers (e.g., functional layers such as PHY, MAC, RLC, PDCP, RRC, and SDAP). The one or more processors 202a and 202b may generate one or more Protocol Data Units (PDUs) and/or one or more Service Data Unit (SDUs) according to the descriptions, functions, procedures, proposals, methods, and/or operational flowcharts disclosed in this document. The one or more processors 202a and 202b may generate messages, control information, data, or information according to the descriptions, functions, procedures, proposals, methods, and/or operational flowcharts disclosed in this document. The one or more processors 202a and 202b may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 206a and 206b. The one or more processors 202a and 202b may receive the signals (e.g., baseband signals) from the one or more transceivers 206a and 206b and acquire the PDUs, SDUs, messages, control information, data, or information according to the descriptions, functions, procedures, proposals, methods, and/or operational flowcharts disclosed in this document.

The one or more processors 202a and 202b may be referred to as controllers, microcontrollers, microprocessors, or microcomputers. The one or more processors 202a and 202b may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 202a and 202b. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 202a and 202b or stored in the one or more memories 204a and 204b so as to be driven by the one or more processors 202a and 202b. The descriptions, functions, procedures, proposals, methods, and/or operational flowcharts disclosed in this document may be implemented using firmware or software in the form of code, commands, and/or a set of commands.

The one or more memories 204a and 204b may be connected to the one or more processors 202a and 202b and store various types of data, signals, messages, information, programs, code, instructions, and/or commands. The one or more memories 204a and 204b may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 204a and 204b may be located at the interior and/or exterior of the one or more processors 202a and 202b. The one or more memories 204a and 204b may be connected to the one or more processors 202a and 202b through various technologies such as wired or wireless connection.

The one or more transceivers 206a and 206b may transmit user data, control information, and/or radio signals/channels, mentioned in the methods and/or operational flowcharts of this document, to one or more other devices. The one or more transceivers 206a and 206b may receive user data, control information, and/or radio signals/channels, mentioned in the descriptions, functions, procedures, proposals, methods, and/or operational flowcharts disclosed in this document, from one or more other devices. For example, the one or more transceivers 206a and 206b may be connected to the one or more processors 202a and 202b and transmit and receive radio signals. For example, the one or more processors 202a and 202b may perform control so that the one or more transceivers 206a and 206b may transmit user data, control information, or radio signals to one or more other devices. The one or more processors 202a and 202b may perform control so that the one or more transceivers 206a and 206b may receive user data, control information, or radio signals from one or more other devices. The one or more transceivers 206a and 206b may be connected to the one or more antennas 208a and 208b and the one or more transceivers 206a and 206b may be configured to transmit and receive user data, control information, and/or radio signals/channels, mentioned in the descriptions, functions, procedures, proposals, methods, and/or operational flowcharts disclosed in this document, through the one or more antennas 208a and 208b. In this document, the one or more antennas may be a plurality of physical antennas or a plurality of logical antennas (e.g., antenna ports). The one or more transceivers 206a and 206b may convert received radio signals/channels etc. from RF band signals into baseband signals in order to process received user data, control information, radio signals/channels, etc. using the one or more processors 202a and 202b. The one or more transceivers 206a and 206b may convert the user data, control information, radio signals/channels, etc. processed using the one or more processors 202a and 202b from the base band signals into the RF band signals. To this end, the one or more transceivers 206a and 206b may include (analog) oscillators and/or filters.

### Thz Communication

In a THz communication system, two main transmission/reception design methods are considered.

The first method is an up-conversion method in which information is loaded in a base band, modulated into a target band (i.e., a THz band), and transmitted or received like in a conventional communication system. However, there is an issue that development of a THz hardware device capable of realizing this should be preceded.

The other method is a down-conversion method. This method gains popularity for transmission/reception systems thanks to the advert of optical-to-electrical converter elements. The O/E converter performs modulation using a source, such as a laser, which has been conventionally used in an infrared radio band, and down-modulates an infrared band to a terahertz band (THz band).

If a transceiver has a hybrid structure that supports both up-conversion and down-conversion, the transceiver may be greatly affected by random phase noise. Therefore, according to the present disclosure, a transmission procedure and transmission configuration for securing transmission reliability are proposed, wherein differential phase shift keying (DPSK) modulation may be used to reduce random phase noise in the allocated frequency resources (e.g., component carriers, BWP, etc.) for down conversion. Hereinafter, matters related to the generation of terahertz pulses are described.

Terahertz pulses (THz pulses) may be generated using a photonic source. Specifically, the primary method used to generate the aforementioned terahertz pulses is to first create a photonic source using infrared lasers (with a sampling resolution of approximately 70 fs) and then modulate this source into the terahertz band. The advantages of such a photonic source-based terahertz communication system are as follows.

Terahertz communication systems may be easily implemented using existing devices. In addition, high transmission speeds may be provided through optical generators and modulators. High sampling rates (up to approximately Peta (10¹⁵) level (fs) for single carrier) may be provided. Therefore, not only 100 Gbps-class but also higher bandwidth (THz-class) may be supported. Additionally, high transmission power using lasers may be provided. In other words, broadband transmission becomes possible.

On the other hand, the above method has the following disadvantages.
Dispersion due to limitations of the optical generator itself (e.g., chromatic dispersion, polarization mode dispersion) and laser noise.
Velocity matching of the modulator.
Effects of nonlinear optical devices during down conversion.
Problems with the utilization of allocatable spectrum.

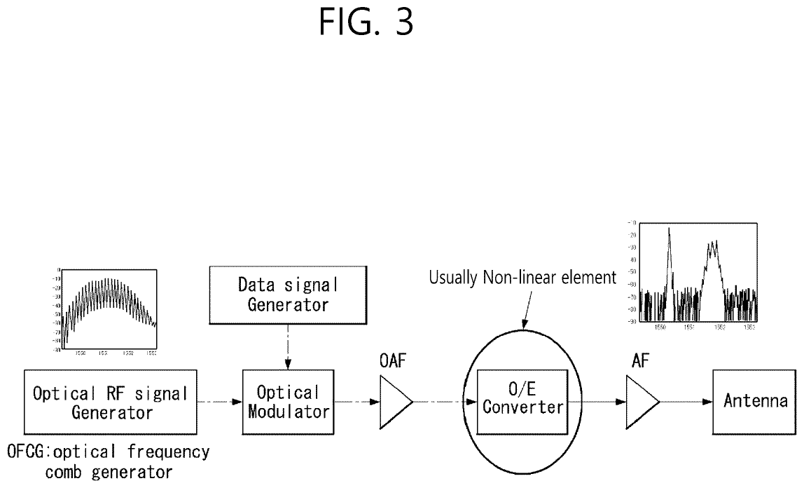

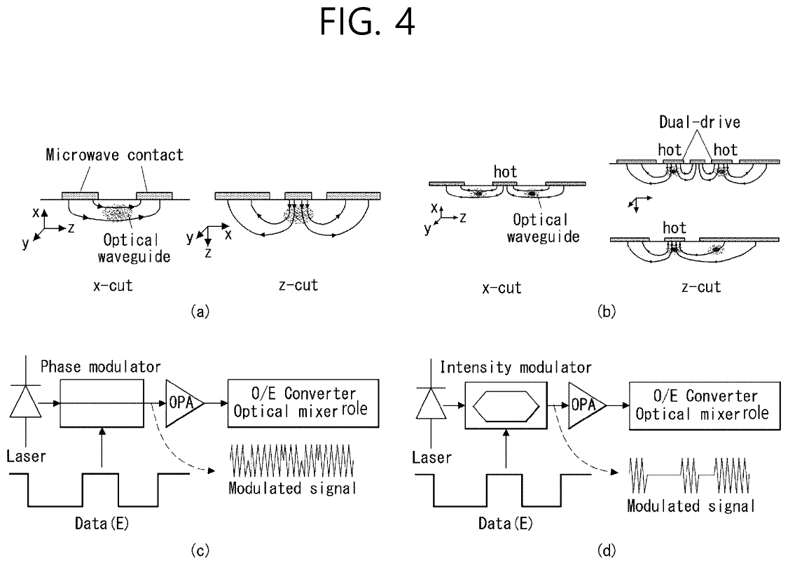

For photon source-based transmission and reception, a transmitter such as that shown in FIG. 3 may be used. Optical modulators may be distinguished into phase modulators and intensity modulators, as shown in FIG. 4.

Generally, by passing the optical source of a laser through an optical wave guide, the phase of the signal may be changed. At this point, by changing the electrical characteristics through a microwave contact, data is loaded. Therefore, the optical modulator output is formed as a modulated waveform.

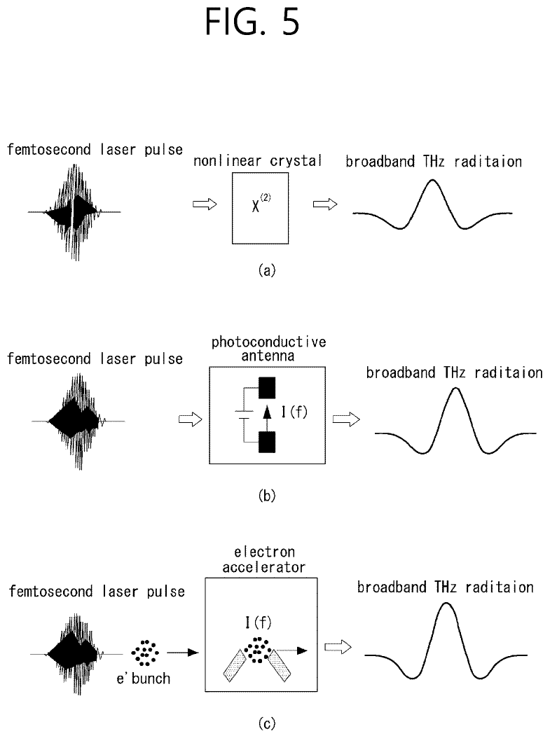

FIG. 5 shows an example of the operation scheme of an optical to electrical converter (O/E converter) according to an embodiment of the present disclosure. The optical to electrical converter may generate terahertz pulses according to the scheme shown in FIG. 5(a) to FIG. 5(c).

For example, terahertz pulses may be generated through optical rectification by a nonlinear crystal, as shown in FIG. 5(a). Another example, terahertz pulses may be generated through O/E conversion by a photoconductive antenna, as shown in FIG. 5(b). Another example, a terahertz pulse may be generated through emission from a bunch of relativistic electrons of the speed of the light, as shown in FIG. 5(c).

The O/E modulator described in FIG. 5 may generate terahertz pulses (THz pulses) with the length in units of femtoseconds to picoseconds.

As shown in FIG. 5, an O/E modulator performs down conversion by using the nonlinearity of an element. The nonlinearity of an element can cause several phenomena. For example, a phenomenon called the Pockels effect is a phenomenon that causes polarization changes due to non-linearity. The Pockels effect may be expressed as shown in [Equation 1] below.

$$n ( E ) = n - \frac{1}{2} r \cdot {n}^{3} E , \qquad [ Equation 1 ]$$

$$r = - 2 \frac{{a}_{1}}{{n}^{3}}$$

In Equation 1, n(E) denotes the Pockels effect, n denotes the refractive index, E denotes the electric field, and r denotes the Pockels coefficient.

As another example, there is a phenomenon called the Kerr effect, in which the refractive index changes due to the non-linearity of a material. The Kerr effect may be expressed by Equation 2 below.

$$n ( E ) = n - \frac{1}{2} s \cdot {n}^{3} {E}^{2} , \qquad [ Equation 2 ]$$

$$s = - \frac{{a}_{2}}{{n}^{3}}$$

In Equation 2, n(E) denotes the Curie effect, n denotes the refractive index, E denotes the electric field, and s denotes the Curie coefficient.

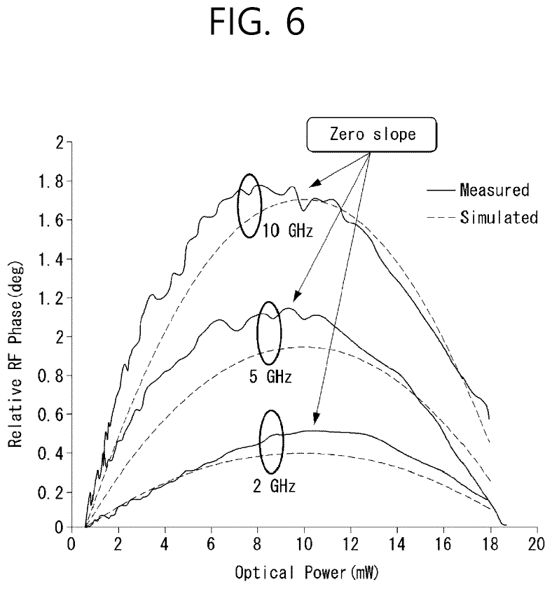

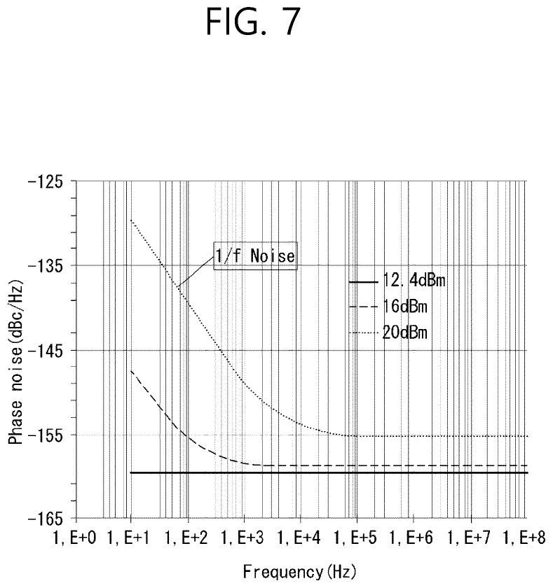

Basically, the Kerr effect causes self-phase modulation (SPM), cross-phase modulation (CPM), and/or four-wave mixing (FWM) phenomenon. The aforementioned phenomenon is related to phase error. In this regard, FIGS. 6 and 7 show examples of phase noise. FIG. 6 is a graph showing RF phase according to input power, and FIG. 7 is a graph showing phase noise according to optical power level around a radio frequency carrier of 10 GHz.

As shown in Equation 2, the Kerr effect may be determined not only by the deformation of the medium but also by the electric field or electric force input into the nonlinear element.

A Kerr signal is generated to measure the phenomenon for the Kerr effect. The Kerr signal may be determined by normalizing the difference between the received signal and the signal without the Kerr effect. The Kerr signal may be expressed as Equation 3 below.

$$\frac{ΔI}{I} = sin \frac{Δ n ω L}{c} , \qquad [ Equation 3 ]$$

$$where$$

$$Δ n ( {ω}^{′} ) = 2 {n}_{2} < E ( ω ) E ( ω ) > ,$$

$$and$$

$${n}_{2} = \frac{3}{2 {n}_{0}} {χ}^{( 3 )} ( {ω}^{′} )$$

In Equation 3, ω denotes angular speed, L denotes the length of the medium, Δn denotes the refractive index change, n₂ denotes nonlinear refractive index in terms of intensity, <E(ω)E(ω)> denotes the average of electric field, n₀ denotes linear refractive index, χ⁽³⁾ denotes the third-order nonlinear susceptibility.

Table 1 below summarizes the parameters related to the Kerr signal for each material.

TABLE 1

| | Δn | K | n₂¹ | n₂¹ [3] | χ⁽³⁾ | τ₀ |
|---|---|---|---|---|---|---|
| Liquid | ×10⁻⁴ | (10⁻¹⁴ m/V) | (10⁻¹⁶ cm²/W) | (10⁻¹⁶ cm²/W) | (10⁻²⁰ m²/V²) | (ps) |
| CS₂ | 4.3 | 2.4 | 440 | 332 | 2.08 | 1.7 |
| Benzene | 0.5 | 0.26 | 56 | 168 | 0.22 | 2.1 |
| CCl₄ | 0.23 | 0.12 | 27 | 15 | 0.10 | — |
| CHCl₃ | 0.086 | 0.045 | 10 | 30 | 0.04 | — |
| CH₂I₂ | 1.4 | 0.75 | 140 | 147 | 0.70 | 13 |

In [Table 1], Δn denotes refractive index change, K denotes Kerr constant, n₂^{I} denotes nonlinear refractive index of Kerr effect, n₂^{I}[3] denotes the third-order nonlinear refractive index, χ⁽³⁾ denotes the third-order nonlinear susceptibility, to denotes rotational relaxation time constant for the THz Kerr effect in various liquids. The measured THz pulse parameters used for the calculation may corresponds to duration 1 ps, beam diameter at focus 2 mm, energy 1.5 μJ. It corresponds to the peak field of 150 kV/cm and the peak intensity of 50 MW/cm2.

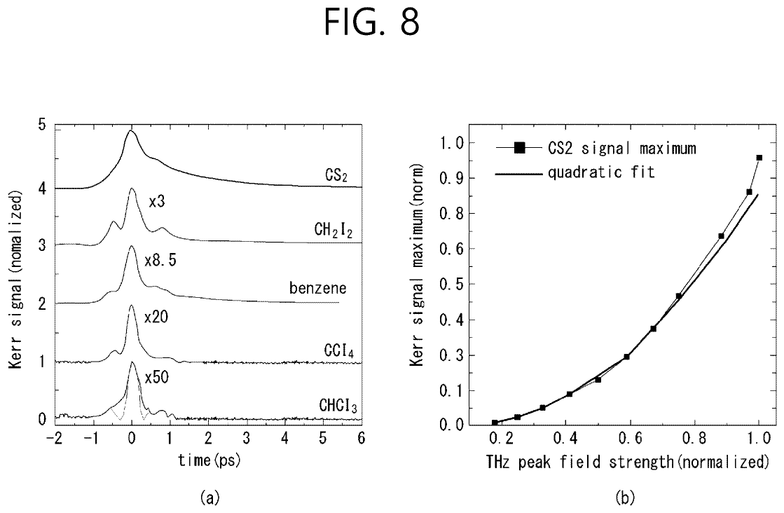

As shown in Table 1, the Kerr effect caused by nonlinearity may vary depending on the material used to implement the O/E converter. This is because, in theory, the value varies according to the third-order susceptibility. Kerr signals occur in different forms depending on the characteristics of the medium and the intensity of the input signal. FIG. 8 shows examples of Kerr signals. Specifically, FIG. 8(a) is a graph showing Kerr signals according to the material, and FIG. 8(b) is a graph showing Kerr signals according to the THz peak field strength.

Hereinafter, matters related to terahertz phase shift keying (THz DPSK) based on a photon source are described. Transmission and reception of THz signals using a photon source may be implemented based on DPSK according to the structure of phase shifters.

DPSK has the following advantages since pulses are transmitted based on differences in information. With DPSK, it is possible to detect the current received signal information compared to the previous signal and estimate the phase difference through reception signal detection. In addition, there is no need to design a reference signal for estimating phase errors in the framework.

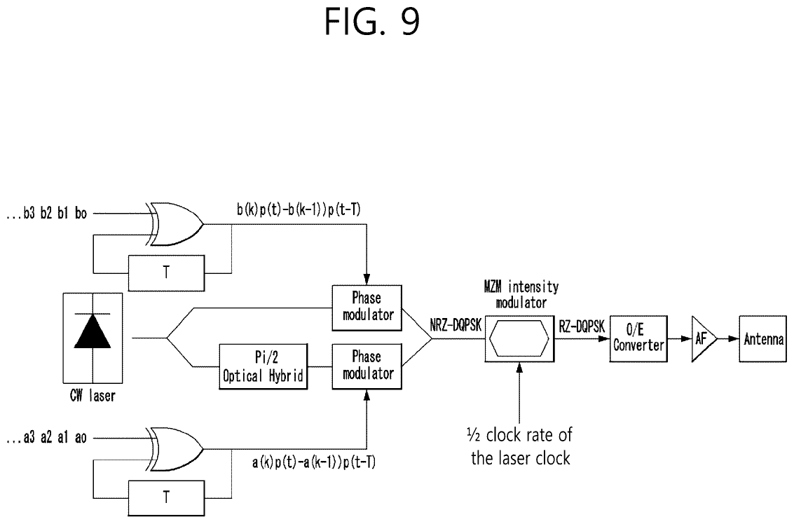

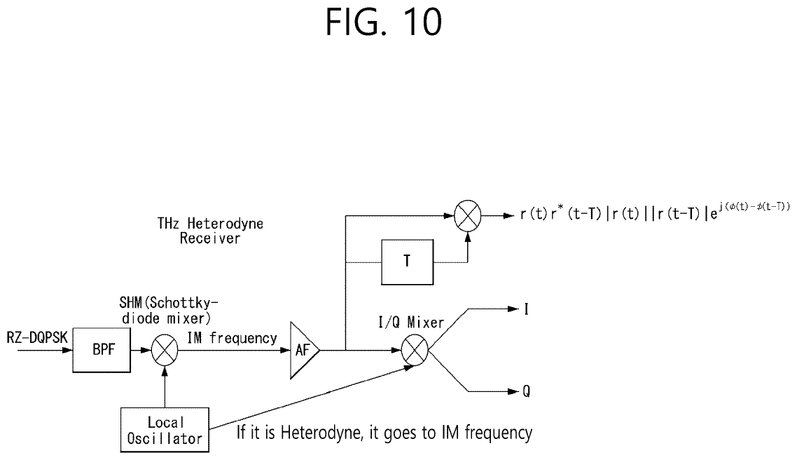

FIGS. 9 and 10 are drawings for explaining the photonic source-based differential quadrature phase shift keying that may be applied to the method proposed in the present specification.

FIG. 9 shows an example of a structure of a photonic source-based THz transmitter to which DQPSK is applied, and FIG. 10 shows an example of a structure of a THz heterodyne receiver.

The following describes matters related to the THz spectrum usage. Plans related to spectrum usage up to 1 THz may be classified as follows.

WRC-12: All frequencies in the range 1000-3000 GHz may be used by both active and passive services
radio astronomy service: 275-323 GHZ, 327-371 GHZ, 388-424 GHZ, 426-442 GHZ, 453-510 GHZ, 623-711 GHz, 795-909 GHz and 926-945 GHz;
[Earth exploration-satellite service (passive) and space research service (passive)]: 275-286 GHz, 296-306 GHZ, 313-356 GHz, 361-365 GHZ, 369-392 GHz, 397-399 GHz, 409-411 GHz, 416-434 GHz, 439-467 GHZ, 477-502 GHZ, 523-527 GHz, 538-581 GHz, 611-630 GHz, 634-654 GHZ, 657-692 GHZ, 713-718 GHZ, 729-733 GHZ, 750-754 GHZ, 771-776 GHz, 823-846 GHZ, 850-854 GHz, 857-862 GHZ, 866-882 GHz, 905-928 GHz, 951-956 GHz, 968-973 GHz and 985-990 GHz.

WRC-15: (Korea) 128-130 GHz, 171-171.6 GHZ, 172.2-172.8 GHz and 173.3-174 GHz are also allocated to the radio astronomy service on a primary basis. Not claim protection from, or constrain the use and development of, services in other countries operating in accordance with the Radio Regulations.

WRC-19: (agenda 1.15) 275~450 GHz related spectrum confirmation plan (related to Land mobile, fixed service)

Spectrum usage Plan (Mobile, Fixed): it is the same between America and Europe.

FCC: 102~109.5, 111.8~114.25, 122.25~123, 130~134, 141~148.5, 151.5~164, 167~174.8, 191.8~200, 209~226, 231.5~235, 238~241, 252~275 GHz.

CEPT (ERC): 102~109.5, 111.8~114.25, 122.25~123, 130~134, 141~148.5, 151.5~164, 167~174.8, 191.8~200, 209~226, 231.5~235, 238~241, 252~275 GHz.

Referring to the plans related to the spectrum usage described above, it is highly likely that multiple contiguous GHz bands will be used for fixed or mobile services for terahertz systems.

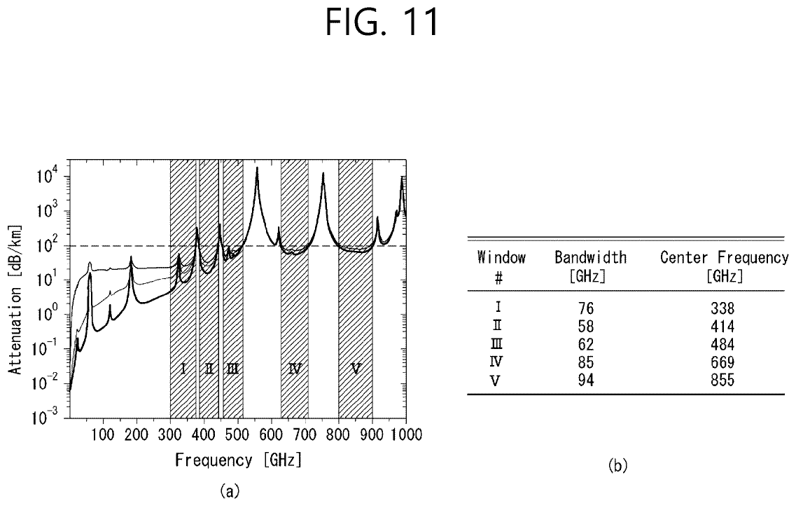

FIG. 11 shows an example of an available band up to 1 terahertz considering signal attenuation according to an embodiment of the present disclosure. FIG. 11(a) is a graph showing signal attenuation up to 1 THz, and FIG. 11(b) is a table summarizing the bandwidth and center frequency of the available range based on a specific signal attenuation value (10\hat{ }2 dB/km).

According to the outdoor scenario shown in FIG. 11, the available bandwidth may be classified based on oxygen attenuation of 10\hat{ }2 dB/km in the spectrum up to 1 THz. Accordingly, a framework in which the above available bandwidth is composed of multiple band chunks may be considered.

As an example of the above framework, if the length of the terahertz pulse is configured to 50 ps for one carrier, the bandwidth becomes approximately 20 GHz. In b of FIG. 11, when each window corresponds to one chunk, each chunk may be configured with two to four carriers.

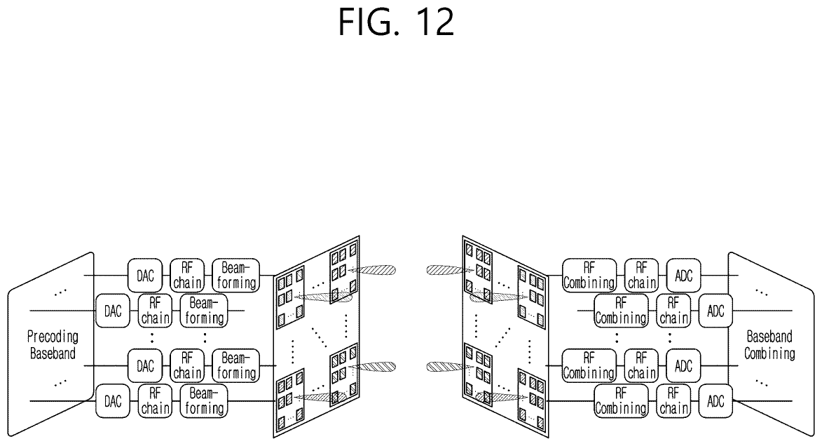

FIG. 12 shows an example of a model of a terahertz band communication system according to an embodiment of the present disclosure. A typical physical layer (PHY layer) transmission and reception system may be composed of frame generation, modulation, pulse shaping, pre-equalization, noise filtering, frame synchronization, post-equalization, and demodulation.

The baseband processor may digitalize the original information. The digitalized information may be encoded, modulated, and up-converted to the desired frequency through a frequency conversion structure before being transmitted by an antenna. A single detection diode may be used for envelope detection. The availability of such devices may determine the emergence and potential success of THz ultra-wideband wireless communication. Many detection methods are being considered for detecting terahertz signals. Direct detection methods have a simple and cost-effective configuration, but they have low sensitivity and require amplifiers to extend the transmission range. In contrast, heterodyne detection methods may improve the sensitivity of the receiver and increase the transmission data rate using vector modulation scheme. Therefore, system performance may be further improved in the digital processing stage.

Communication in the sub-THz (e.g., 100 GHz or above) band may be designed to use the existing mmWave baseband and front-end structures as is. In this case, since the band has a short wavelength, communication elements (e.g., LNA, MIXER, Filter) must be developed together using semiconductor processes such as CMOS, as the line loss of the front-end is large.

### SPECIFIC EMBODIMENT OF THE PRESENT DISCLOSURE

Hereinafter, the present disclosure describes a technique for generating and transmitting a signal in a target band using down conversion. Specifically, the present disclosure describes various embodiments for generating a signal to be transmitted via a wireless channel by down converting a signal in a band higher than the usage band and transmitting the generated signal using a frame structure suitable for the characteristics of the generated signal. In addition, according to the present disclosure, matters related to phase error of an optical to electrical converter (O/E converter) are explained in more detail. Effective down conversion from the infrared band (IR band) to the terahertz band depends on how the nonlinearity of the optical to electrical converter is utilized.

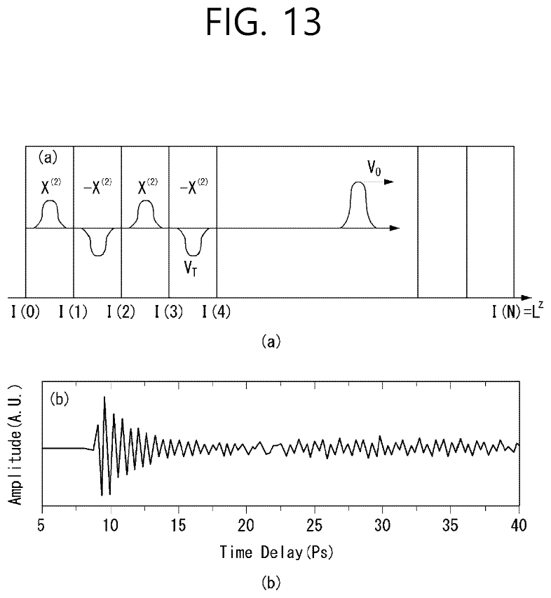

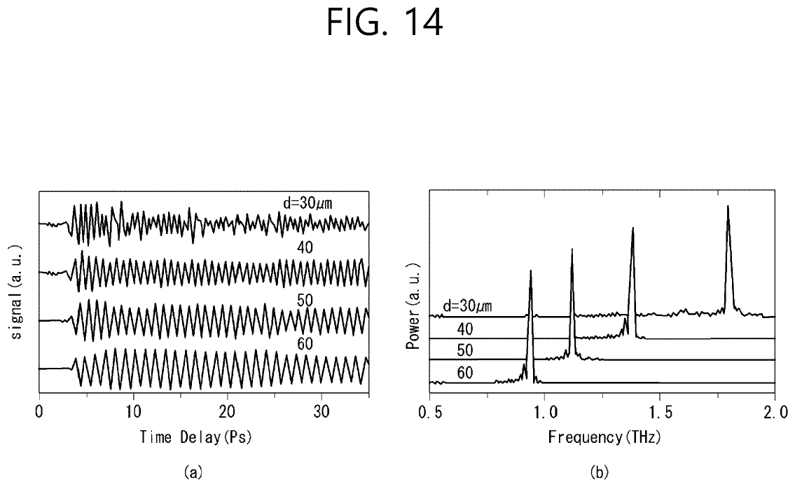

In order to down-convert signals to the intended band (e.g., THz band), it is required to design an O/E converter with the most ideal nonlinearity for transferring to the corresponding terahertz band. If an O/E converter that does not match the target frequency band is used, errors are likely to occur in the amplitude and phase of the corresponding pulses. FIGS. 13 and 14 show examples of this.

FIG. 13 shows an example of terahertz pulses according to an embodiment of the present disclosure. Specifically, FIG. 13(a) shows examples of a plurality of terahertz pulses in periodically poled lithium niobate (PPLN), and FIG. 13(b) shows an example of generation of THz waves through optical rectification in PPLN.

FIG. 14 shows an example of the relationship between the medium form and modulation in an O/E converter according to an embodiment of the present disclosure. Referring to FIG. 14(b), the target frequency varies depending on the structure of the O/E converter.

In a single carrier system, a terahertz transmission and reception system may be implemented by using one O/E converter. Although it depends on the channel environment, in a multi carrier system, O/E converters may be required as much as the number of carriers. Especially in the case of a multi-carrier system using several broadband channels according to the plans related to the aforementioned spectrum usage, this phenomenon will be prominent. In this regard, a frame structure for a multi-carrier system may be considered.

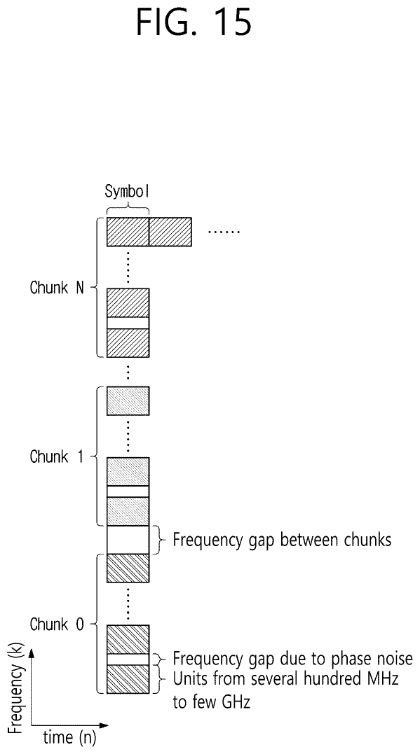

FIG. 15 shows an example of a frame structure for a terahertz multi-carrier system according to an embodiment of the present disclosure.

Referring to FIG. 15, the signal down-converted by using the O/E converter may be transmitted in a specific resource region (e.g., a specific frame). The frequency region of the specific resource region may include a plurality of chunks. According to an embodiment, one chunk is a unit resource in the frequency axis for transmitting a signal output from one O/E converter. That is, the frequency axis size of a chunk may be determined based on the output bandwidth of the O/E converter. Here, the output bandwidth of the O/E converter may be determined by considering the phase error between the one side and the other side of the band, and may be determined so that the phase error is within a tolerance, for example. Therefore, the frequency axis size of the chunk can be understood as being determined based on the phase error between the two ends of the output band of the O/E converter and the tolerance for the phase error. Alternatively, the frequency axis size of the chunk may be determined based on the number of optical signals that a single O/E converter can accept as input. A single chunk occupies a contiguous band. The criteria for determining the size and/or structure of a single chunk may be defined in various ways and are not limited to a single specific criterion. For example, a single chunk may be defined as a contiguous band in which errors occur within a certain tolerance range based on the down conversion operation of a single O/E converter.

When a plurality of chunks are configured, a frequency gap between the chunks may be configured. The frequency gap between the chunks may be determined based on phase noise. That is, the frequency gap between the chunks may be understood as a guard band that considers phase noise.

A chunk may include at least one sub-chunk. According to an embodiment, a sub-chunk may be a unit resource for transmitting a single optical signal. The frequency bandwidth of each sub-chunk may be from several hundred MHz to several GHz. In addition, considering phase noise, a frequency gap between sub-chunks may be configured. The frequency gap between sub-chunks may be determined based on the loss due to phase noise. The transmission device may determine the frequency degree at which the loss due to phase noise is negligible as a K value, and configure the frequency gap between sub-chunks based on 1/K.

According to an embodiment, phase noise of 1/K [dBc/Hz] may be allowed between adjacent sub-chunks. When the phase noise loss between adjacent sub-chunks is negligible, the gap between adjacent sub-chunks should be K [Hz] or more. According to an embodiment, assuming an environment having a loss model for the above phase noise between adjacent sub-chunks with a sub-chunk bandwidth of 10 GHz as shown in FIG. 7, the threshold value for the phase noise may be configured to −155 dBc/Hz. In this case, the frequency gap between sub-chunks may be configured to 10 kHz or more. Therefore, the phase noise of signals deviating from 10 kHz from the reference carrier may be reduced to a negligible level of −155 dBc/Hz or less.

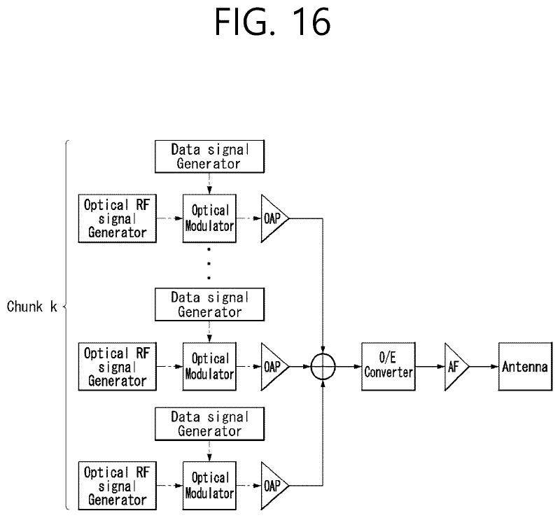

FIG. 16 shows an example of a structure of a terahertz transmitter based on a photon source according to an embodiment of the present disclosure. Specifically, FIG. 16 shows a structure of a THz transmitter based on a photon source for one chunk.

As shown in FIG. 16, one sub-chunk signal may be generated by modulating a signal generated by an optical wireless signal generator using an optical modulator based on a data signal. When a plurality of sub-chunks are included in a chunk, the signals of the sub-chunk signals may be summed. Thereafter, the frequencies of the summed optical signals are down-converted through an O/E converter, and the transmitter transmits the signal through an antenna.

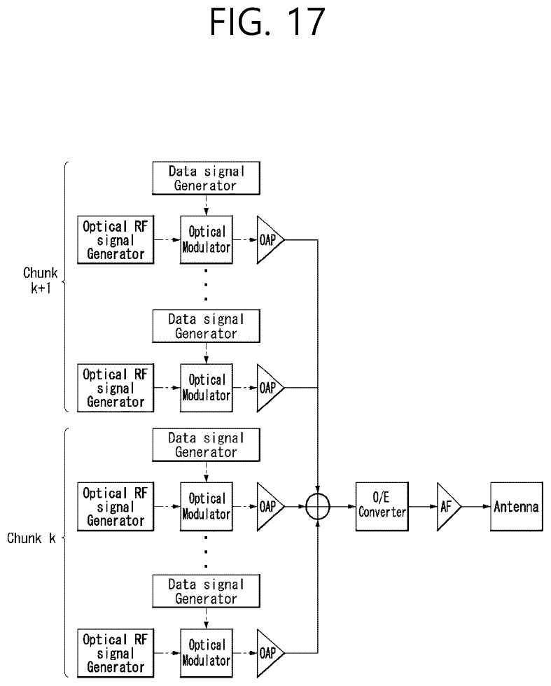

As another example, as shown in FIG. 17, a plurality of frequency band chunks may be configured to correspond to a single O/E converter. A setting value may be defined for the number of chunks corresponding to a multiple carrier transmitter. In this case, a plurality of chunks may be defined to correspond to a single O/E converter.

In a structure including the above-described chunk and sub-chunk, a DPSK modulation scheme may be applied to reduce the effect of random phase noise generated between chunks within a certain frequency band.

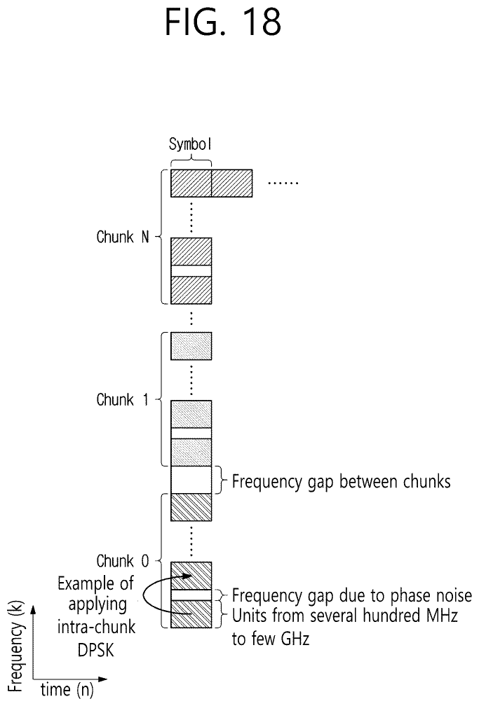

FIG. 18 shows an example of a frame structure for reducing phase error values between chunks or sub-chunks according to an embodiment of the present disclosure. According to the frame structure shown in FIG. 18, sub-chunks are included within each chunk, and the bandwidth of each sub-chunk may be from several hundred MHz to several GHz. The frame structure includes a frequency gap to prevent loss due to phase noise between sub-chunks. In addition, a frequency gap between chunks may also be included.

In the frame structure, chunks may be configured as contiguous or non-contiguous. If a plurality of chunks correspond to a single O/E converter, additional errors may occur due to O/E converter mismatch except for the main chunk among the plurality of chunks. Here, the main chunk refers to the chunk in which the target band of the O/E converter is included when a single O/E converter is used.

Specifically, phase error due to the Kerr effect and phase noise due to O/E converter mismatch may occur together according to the down conversion operation of the O/E converter. Phase error due to the Kerr effect may be related to magnetic phase modulation, cross phase modulation, and/or the four-wave mixing phenomenon. When there are not many sub-chunks in a chunk, if a reference signal is transmitted for phase noise tracking, tracking with respect to time is required, and therefore the overhead required for reference signal signaling increases. In order to reduce the signaling overhead, a method for efficiently removing phase noise may be required.

Therefore, by applying DPSK between sub-chunks and/or between chunks, the overall phase error including the phase error of the channel may be estimated at the receiver side. In this case, when implementing a multi-carrier system, it is possible to reduce the number of O/E converters while estimating the frequency/time phase noise without additional reference signal transmission operations.

In the frame structure described above, the configuration related to one carrier in a chunk consists of an optical generator, an optical modulator, and an optical amplifier in that order. In this frame structure, estimation for magnetic phase modulation, cross phase modulation, four-wave mixing, and/or phase error in the main chunk may be performed first or ignored.

If self-phase modulation, cross-phase modulation, 4-wave mixing, and/or phase error estimation are required within the main chunk, DPSK may be performed on the time axis. In this case, decoding for the main chunk may be performed first from the UE perspective. On the other hand, if self-phase modulation, cross-phase modulation, 4-wave mixing, and/or phase error estimation within the main chunk ignore errors, no pre-decoding of the main chunk is necessary from the UE perspective.

Through the frame structure described above, wireless devices may transmit terahertz signals using DPSK.

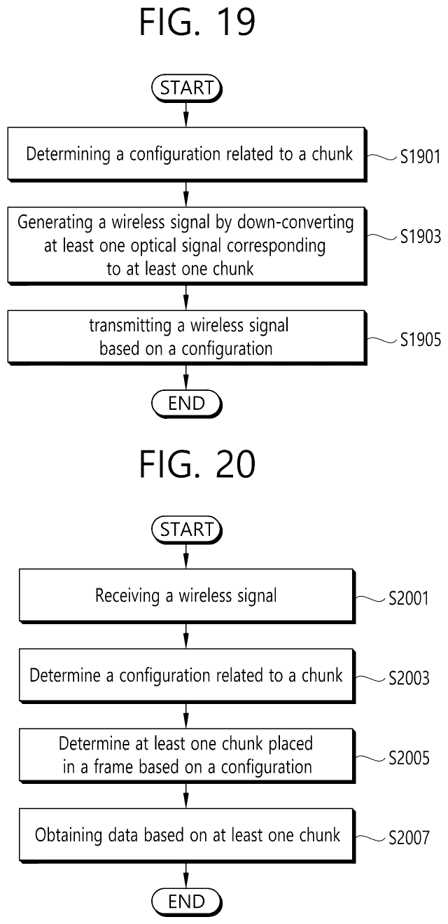

FIG. 19 shows an example of a procedure for transmitting a radio signal using down conversion according to an embodiment of the present disclosure. FIG. 19 shows an example of a method performed by a first device that transmits a signal.

Referring to FIG. 19, in step S1901, a first device determines a configuration related to a chunk. The configuration related to a chunk may be related to the first frame structure described in FIGS. 15 to 18. That is, the first device may determine a configuration related to a structure of a chunk, the number of chunks, a structure of gaps between chunks, a structure of sub-chunks, etc. For example, the first device may determine a configuration related to a chunk by determining information (e.g., phase noise-related information) used as a criterion for determining the structure of a chunk and/or a sub-chunk, and determining at least one parameter that specifies the structure of a chunk and/or a sub-chunk based on the determined information. In another example, the first device may determine a configuration related to a chunk by receiving configuration information related to the chunk from another device.

In step S1903, the first device generates a wireless signal by down-converting at least one optical signal corresponding to at least one chunk. For example, the wireless signal may be a signal in the THz band. As described with reference to FIG. 16, one sub-chunk signal may be generated based on the optical signal and the data signal. If a plurality of sub-chunks exist in a single chunk, the first device may generate a wireless signal by down-converting the summed sub-chunk signals using an O/E converter. If a plurality of chunks are configured, the first device may use a plurality of O/E converters.

In step S1905, the first device transmits a wireless signal based on the determined configuration. The first device may map at least one chunk to the first frame based on the configuration for the first frame structure. Thus, the first device may transmit a wireless signal using at least one chunk mapped to the first frame.

FIG. 20 shows an example of a procedure for receiving a wireless signal using down conversion according to an embodiment of the present disclosure. FIG. 20 shows an example of a method performed by a second device that receives a signal.

Referring to FIG. 20, in step S2001, a second device receives a wireless signal. At this time, the wireless signal is mapped to at least a part of a carrier corresponding to the entire frame. Therefore, the second device may extract the wireless signal as follows according to the structure of the frame.

In step S2003, the second device determines the configuration related to the chunk. Since a wireless signal is transmitted using at least one chunk, it is necessary to determine the structure of the chunk in order to process the wireless signal. The configuration related to the chunk specifies the structure of the chunk and sub-chunks, and may include, for example, at least one of the frequency gap between the chunks, the number of sub-chunks included in each of the chunks, and the frequency gap between the sub-chunks. The second device may obtain the configuration related to the chunk in various ways. For example, the second device may determine the information used as a criterion for determining the structure of the chunk and/or sub-chunk (e.g., phase noise-related information), and by determining at least one parameter that specifies the structure of the chunk and/or sub-chunk based on the determined information, the second device may determine the configuration related to the chunk. In another example, the second device may determine the configuration related to the chunk by receiving configuration information related to the chunk from another device.

In step S2005, the second device determines at least one chunk mapped to the frame based on the determined configuration. The second device may extract a signal included in at least one chunk based on the determined configuration. The second device may obtain the data transmitted by the first device by decoding the extracted down-converted signal. At this time, the second device may decode the data after up-converting the wireless signal into an optical signal. Alternatively, the second device may obtain the data from the wireless signal by performing decoding without up-conversion.

According to the embodiments described with reference to FIGS. 19 to 20, the devices may perform data communication using the down-converted signal. At this time, a DPSK modulation scheme may be used to reduce random phase noise. In addition, when a hybrid transceiver in which up conversion and down conversion are mixed is used, at least one of the frame structures and numerologies for cells, component carriers (CC), or BWPs may be required.

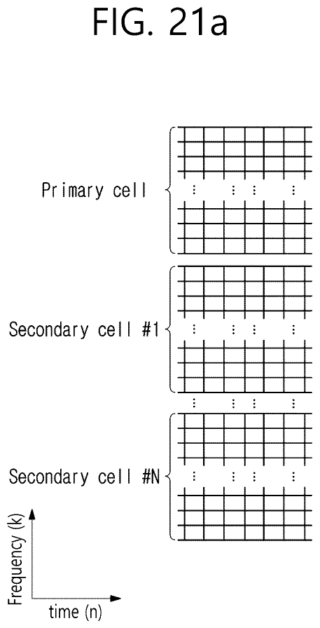

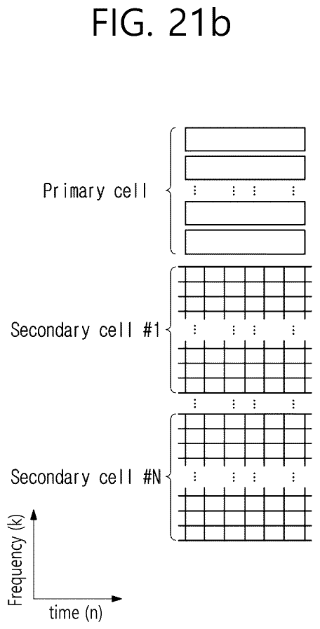

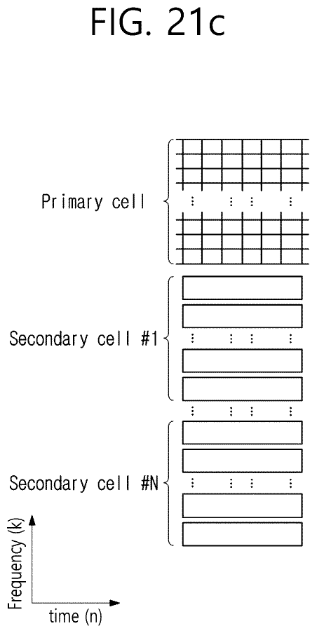

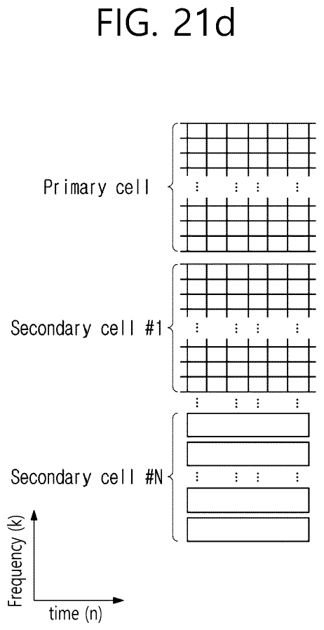

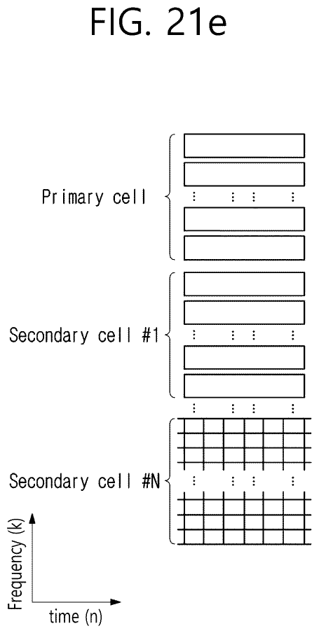

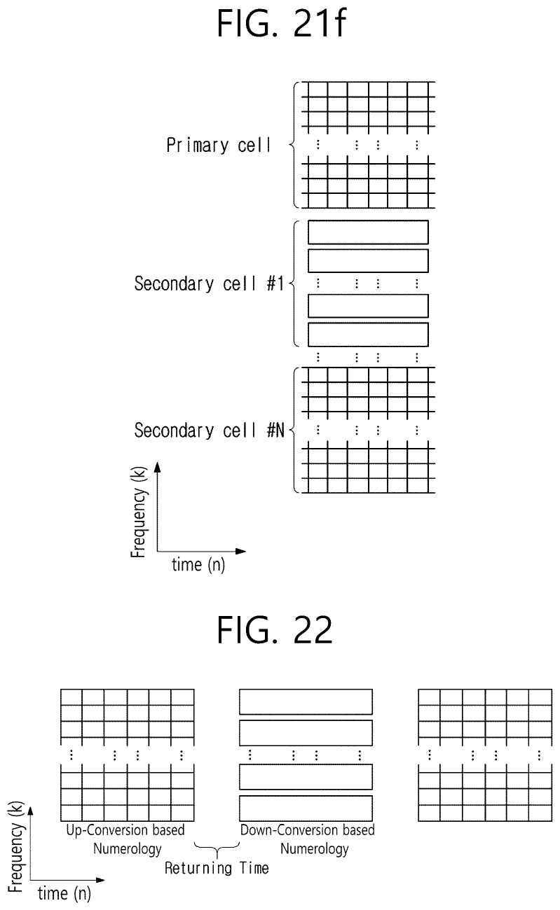

FIGS. 21a to 21f show examples of frame structures according to embodiments of the present disclosure. FIGS. 21a to 21f exemplify various combinations of two different frame structures and numerologies. In FIGS. 21a to 21f, a photon-based frame structure using down conversion (hereinafter referred to as the “first frame structure”) is expressed in a block form, and an OFDM-based frame structure using up conversion (hereinafter referred to as the “second frame structure”) is expressed in a lattice form.

As shown in FIGS. 21a to 21f, the first frame structure and the second frame structure may be combined in various ways. According to one embodiment, both the primary cells and the secondary cells may be configured as a single frame structure. For example, both the primary cells and the secondary cells may be configured as the first frame structure. In another example, as shown in FIG. 21a, both the primary cells and the secondary cells may be configured as a second frame structure. In other embodiments, the primary cells and the secondary cells may be configured as different frame structures. For example, as shown in FIG. 21b, the primary cell may be configured as a first frame structure, and the secondary cells may be configured as a second frame structure. In another example, as shown in FIG. 21c, the primary cell may be configured as a second frame structure, and the secondary cells may be configured as a first frame structure.

In another embodiment, some of the secondary cells may be configured as a first frame structure and the rest may be configured as a second frame structure. For example, as shown in FIG. 21d, the primary cell may be configured as a second frame structure, and the secondary cells may be configured as a second frame structure and a first frame structure. In this case, the number of cells configured as the second frame structure may be set to K. Therefore, the first secondary cell to the Kth secondary cell may be configured as the second frame structure, and the K+1th secondary cell to the Nth secondary cell may be configured as the first frame structure. As another example, as shown in FIG. 21e, the primary cells may be configured as the first frame structure, and the secondary cells may be configured as the first frame structure and the second frame structure. In this case, the number of cells configured as the first frame structure may be set to K. Therefore, the first secondary cell to the Kth secondary cell may be configured as the first frame structure, and the K+1th secondary cell to the Nth secondary cell may be configured as the second frame structure.

In addition, a single frame structure does not necessarily need to be applied to all contiguous cells. For example, as shown in FIG. 21f, cells configured as a first frame structure may be mapped between cells configured as a second frame structure. Therefore, only specific cells may be configured as a first frame structure, while the remaining cells may be configured as a second frame structure.

In FIGS. 21a to 21f, the frame structure is applied in cell units. However, according to various embodiments, the frame structure may be configured in other units such as CC and BWP, etc. The configuration for numerology and frame structure may be signaled through the upper layer, such as the radio resource control (RRC) layer or the medium access control (MAC) layer. When configuration is performed through the MAC layer, MAC-CE may be used.

As described above, in the frequency axis, it may be configured so that the first frame structure and the second frame structure are mixed. In addition, conversion of the frame structure according to numerology may also be performed in the time axis, as shown in FIG. 22.

FIG. 22 shows an example of a change in the frame structure based on the time division duplexing (TDD) method according to an embodiment of the present disclosure. Referring to FIG. 22, the numerology may be changed from the first frame structure to the second frame structure or from the second frame structure to the first frame structure according to the flow of time. In this case, a retuning time for frame structure conversion may be configured. According to an embodiment, the interval to which the first frame structure or the second frame structure is applied may be configured by indicating slots, subframes, frames, or symbols. Alternatively, the interval to which the first frame structure or the second frame structure is applied may be configured through a cell indicator or a transceiver switch indicator. The frame structure and numerology of the TDD form may be configured through the RRC layer or the MAC layer, which are higher layers.

As described above, configurations for frame structure conversion according to the numerology of the hybrid transceiver may be determined through the upper layer for each CC or BWP. The retuning time for frame structure conversion according to the hybrid transceiver numerology may be configured by the upper layer or through independent parameter values. The length of the retuning time may be indicated in various ways. For example, it may be indicated through an 8-bit length bitmap as shown in Table 2 below.

TABLE 2

| Index | 10000000 | 01000000 | 00100000 | 00010000 | 00001000 | 00000100 | 00000010 | 00000001 |
|---|---|---|---|---|---|---|---|---|
| Retuning | 100 ms | 50 ms | 10 ms | 5 ms | 1 ms | 100 us | 10 us | 1 us |

When using a bitmap as shown in Table 2, if the index value is set to “10000000,” the retuning time may be set to 100 ms. According to the embodiment, the retuning time for switching the frame structure according to the numerology conversion may be set to enable/disable. For example, when the retuning time is enabled, the retuning time set through signaling may be applied. For example, when using index values as shown in Table 2, the set retuning time may be set to 10 ms using the index value having a value of “00100000.” At this time, if the retuning time is enabled, a retuning time of 10 ms may be set. In addition, the retuning time may be set in batches within the CC or BWP range. The timing at which the frame structure is changed may be indicated in various ways. For example, when the entire frame structure is configured with N frames, subframes, slots, or symbols, the timing at which the frame structure is converted may be indicated using resource units. For example, when a K value is indicated in the range 0≤K≤N, the frame structure may be changed at the Kth frame, subframe, slot, or symbol. In another example, the point at which a single frame structure ends may be indicated. For example, if a value K is indicated in the range 0≤K≤N−1, the frame structure may be changed at the K+1th frame, subframe, slot, or symbol. At this time, the retuning time may be configured to be equal to M frame(s), subframe(s), slot(s), or symbol(s) according to the frame structure. In this case, the point at which the changed frame structure starts may be the M+Kth or M+K+1th frame, subframe, slot, or symbol.

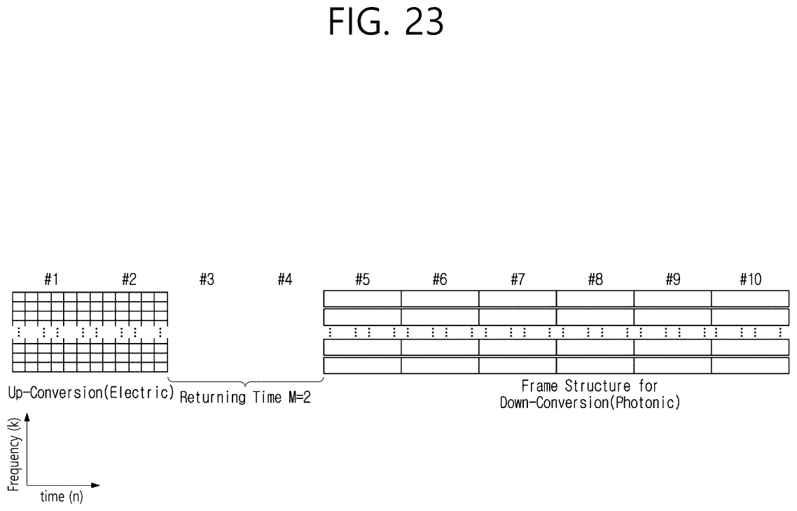

An example of a frame structure change is shown in FIG. 23. FIG. 23 shows an example of a frame structure being changed according to an embodiment of the present disclosure. FIG. 23 shows an example in which K=3 and M=2 are indicated in frames indicated by N=10 indexes. Referring to FIG. 23, the frame structure is changed starting from the third frame, and the first frame structure may be used from the K+M=5th frame. In this way, when the retuning time Mis set by the upper layer and the frame structure is configured to be changed at the Kth frame, subframe, slot, or symbol, the frame structure may be finally changed at the K+Mth frame, subframe, slot, or symbol.

As another example, the point at which the changed frame structure is applied may be designated as K. In this case, the change in the frame structure starts from the K-Mth frame, subframe, slot, or symbol, and the changed frame structure may be applied from the Kth frame, subframe, slot, or symbol.

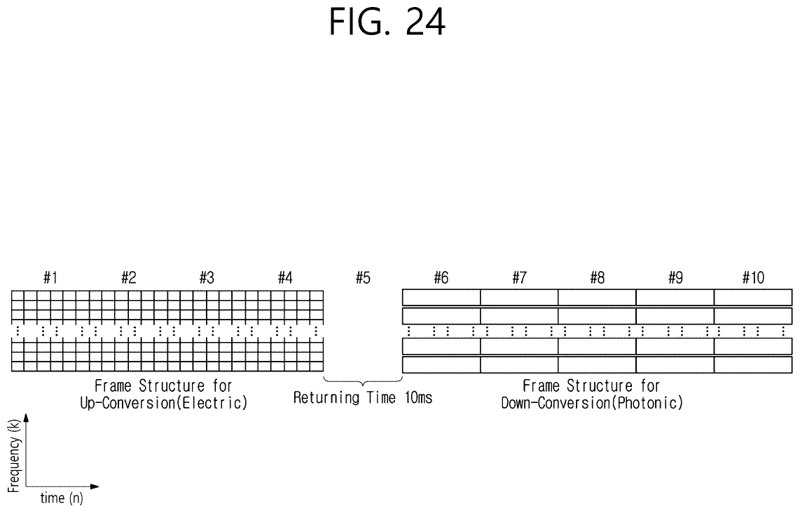

Unlike the above method, the retuning time may be configured as a time length value rather than the number of frames, subframes, slots, or symbols. For example, if K, which indicates the point where the frame structure change starts, is set to 5, and the retuning time is set to 10 ms, the frame structure may be formed as shown in FIG. 24. FIG. 24 shows another example of where the frame structure is changed according to an embodiment of the present disclosure. Referring to FIG. 24, when the frame length is set to 10 ms, the retuning time is required for one frame time. Therefore, retuning starts from the fifth frame, and the frame structure may be changed to a frame structure for down conversion from the sixth frame.

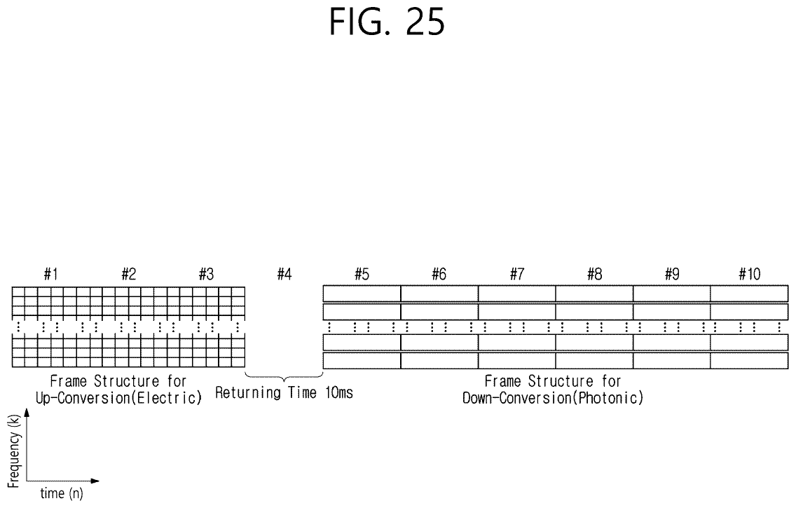

As another example, when K indicating the point at which the frame structure change is completed is set to 5 and the retuning time is set to 10 ms, the frame structure may be formed as shown in FIG. 25. FIG. 25 shows another example of changing the frame structure according to an embodiment of the present disclosure. Referring to FIG. 25, when the frame length is set to 10 ms, the retuning time is required for one frame time. Therefore, the retuning time starts from the fourth frame, and the first frame structure is applied from the fifth frame.

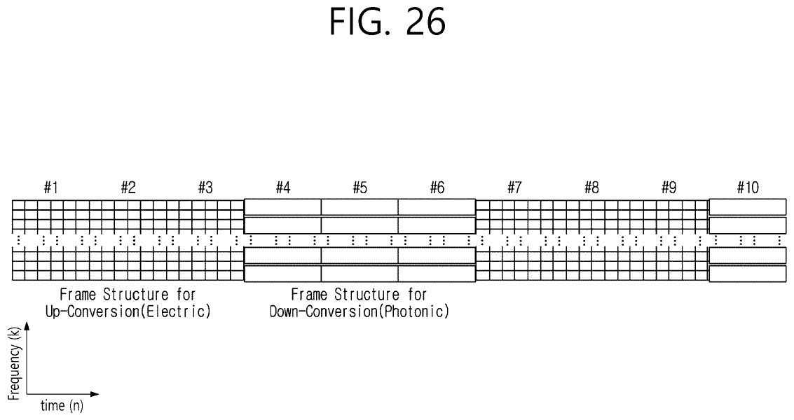

In addition, frame structures for up conversion and frame structures for down conversion may be configured through a bitmap. Therefore, bitmaps may be designated in units of frames, subframes, slots, or symbols. For example, in numerology consisting of 10 frames, if the bitmap is “0001110001,” the frame structure may be applied as shown in FIG. 26. FIG. 26 shows an example in which the frame structure is changed without retuning time according to an embodiment of the present disclosure. Referring to FIG. 26, the first frame to the third frame and the seventh frame to the ninth frame are configured as a second frame structure, and the fourth frame to the sixth frame and the tenth frame are configured as a first frame structure. The configuration using the bitmap may be signaled through the upper layer, such as the RRC layer or the MAC layer.

The embodiments described with reference to FIGS. 23 to 26 show examples of frame structure changes on a frame basis. However, the proposed technology is not limited to these examples. For example, the frame structure may be changed on a subframe, slot, or symbol basis.

Based on the frame structure described above, transmission based on DPSK may be performed to utilize transmission robust to random phase in the transmission of a photon source-based transceiver. The following transmission methods may be considered to improve reliability in the transmission of a photon source-based transceiver.

According to an embodiment, the primary cell is configured as a second frame structure and may be operated using an OFDM scheme, a single carrier-based OFDM scheme, or a NOMA scheme. At least one secondary cell is configured with a first frame structure and may be operated based on DPSK or quadrature phase shift keying (QDPSK). In this case, as another example, some of the secondary cells may be configured as a second frame structure and operated using a conventional modulation scheme.

According to another embodiment, the primary cell is configured with a first frame structure and may operate based on DPSK or QDPSK. At least one secondary cell may be configured with a second frame structure and may operate based on an OFDM scheme, a single carrier-based OFDM scheme, or a NOMA scheme. In this case, as another example, some of the secondary cells may be configured with a first frame structure and may operate based on DPSK or QDPSK.

In order to use DPSK modulation in a frequency region of a resource block (RB) or resource element (RE) unit, information related to the preceding data and following data of DPSK may be required in the CC, BWP, or RB unit of the first frame structure. For example, an index related to the order of the preceding data and the following data of DPSK may be signaled through the upper layer, such as the RRC layer or the MAC layer. At this time, the initial value n₀(t) may be allocated based on the RE of the CC, BWP, or RB of the second frame structure. In addition, the modulation and coding scheme (MSC) of the initial symbol n₀(t) may be configured to be as low as possible. For example, the initial symbol n₀(t) may be configured to be modulated by a binary phase shift keying (BPSK) scheme or to be transmitted repeatedly.

That is, the initial symbol n₀(t) may be allocated to the cell or etc. of the second frame structure, and the initial symbol may be mapped to the REs indicated for phase tracking. The configuration related to the RE region may be configured through the upper layer, i.e., the RRC layer or the MAC layer.

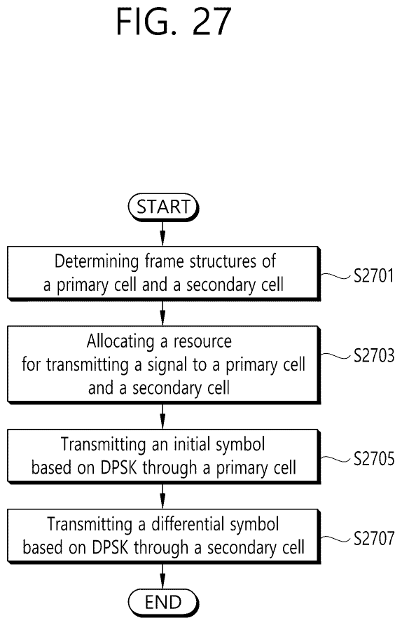

FIG. 27 shows an example of a procedure for transmitting symbols based on DPSK modulation according to an embodiment of the present disclosure. FIG. 27 shows an example of a method performed by a first device for transmitting symbols.

Referring to FIG. 27, in step S2701, the first device determines the frame structure of the primary cell and the secondary cell. The frame structure of the primary cell and the secondary cell may be configured as the frame structure described in FIG. 21a to FIG. 21f. In this embodiment, the first device determines to configure the second frame structure for the primary cell and the first frame structure for the secondary cell.

In step S2703, the first device allocates resources for transmitting signals to the primary cell and secondary cell. The initial symbol may be allocated to a specific region designated for phase tracking. For example, for the initial symbol, all symbols of a frame, subframe, or slot, or L contiguous symbols configured by a start symbol and length indicator value (SLIV) may be allocated. That is, the initial symbol may be allocated individually to specific symbols, or allocated to a specific region of a frame, subframe, or slot through the position and length of the start symbol.

In step S2705, the first device transmits an initial symbol that is based on DPSK via the primary cell. Accordingly, the first device may transmit the initial symbol by using a relatively stable second frame structure. At this time, if a reference signal is configured within the RE region allocated for the initial symbol, transmission of the initial symbol may be omitted according to the following priority. For example, if a demodulation reference signal (DMRS) for a physical downlink shared channel (PDSCH) is configured in the RE region allocated for the initial symbol, the first device may transmit the DMRS for the PDSCH instead of the initial symbol. Or, if channel state information-reference signal (CSI-RS), tracking reference signal (TRS), and phasor tracking reference signal (PTRS) are configured within the RE region allocated for the initial symbol, the reference signals may be transmitted in the order of CSI-RS, TRS, and PTRS. At this time, rate matching or puncturing may be performed for code words mapped to the PDSCH, except for regions to which the initial symbol is allocated.

In step S2707, the first device transmits at least one differential symbol based on DPSK through the secondary cell. That is, differential symbols indicating difference values of subsequent symbols based on the initial symbol are transmitted through the secondary cell of the first frame structure. Accordingly, the first device may transmit the differential symbols at a higher transmission rate. At this time, the differential symbols based on the initial symbol transmitted in step S2705 may be transmitted in the same time interval as the time interval in which the initial symbol is transmitted or in a time interval later than the time interval in which the initial symbol is transmitted.

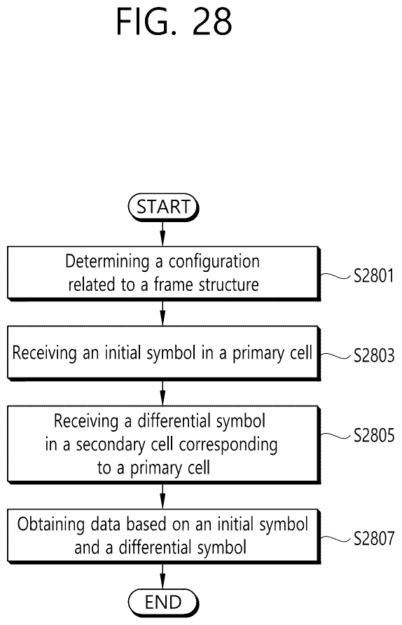

FIG. 28 shows an example of a procedure for receiving symbols based on DPSK modulation according to an embodiment of the present disclosure. FIG. 28 shows an example of a method performed by a second device that receives symbols.

Referring to FIG. 28, in step S2801, the second device determines configuration related to the frame structure. For example, the second device may receive configuration information related to the frame structure from another device (e.g., the first device). In this embodiment, the second device determines to configure the second frame structure for the primary cell and the first frame structure for the secondary cell.

In step S2805, the second device receives an initial symbol in the primary cell. That is, the second device receives an initial symbol in the primary cell of the second frame structure. Accordingly, the second device may transmit the initial symbol by using the relatively stable second frame structure.

In step S2807, the second device receives at least one differential symbol in the secondary cell corresponding to the primary cell. That is, the second device receives at least one differential symbol in three cells of the first frame structure. Accordingly, the second device may receive the differential symbols at a higher transmission rate. At this time, the differential symbols based on the initial symbols received in step S2805 may be received in the same time interval as the time interval in which the initial symbols are transmitted or in a time interval later than the time interval in which the initial symbols are transmitted.

In step S2809, the second device obtains data based on the initial symbol and the differential symbol. The second device may restore the data by demodulating and decoding the initial symbol and at least one differential symbol received in steps S2805 and S2807. For example, the second device may obtain a difference value from the differential symbol with respect to the preceding symbol, and obtain the data represented by the differential symbol by summing the value of the preceding symbol and the difference value.

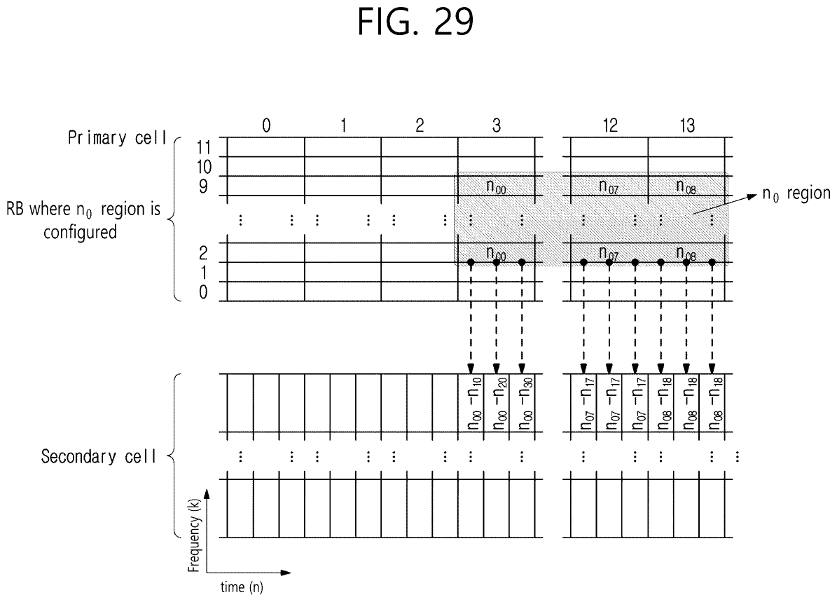

FIG. 29 shows an example of mapping initial symbols and differential symbols based on DPSK modulation according to an embodiment of the present disclosure. In FIG. 29, the initial symbols are expressed in the format ‘n₀ₓ’, where x denotes the order in which the corresponding initial symbol is mapped. Referring to FIG. 29, in one RB containing 12 REs, the configuration for the corresponding n₀ value is enabled, the start of the n₀ region on the frequency axis is set to RE with k=2, and the configuration may be set to repeat in eight REs. Then, on the time axis, one OFDM symbol is allocated for each initial symbol, and symbols #3 to #13 in the PDSCH may be allocated as the n₀ region by SLIV. Specifically, as shown in FIG. 29, the initial symbols n₀₁ to n₀₈ may be mapped to the n₀ region. Specifically, eight contiguous REs may be allocated in the frequency region for n₀₀. In addition, eight contiguous REs may be allocated in the frequency region for n₀₁.

In addition, in the secondary cell, regions corresponding to symbols #3 to #13 of the primary cell may be configured as regions for transmitting differential symbols. The differential symbols may be determined based on the difference values between the data included in the initial symbols and the data to be transmitted. For example, the differential symbols corresponding to the initial symbols n₀₀ may indicate n₀₀-n₁₀, n₀₀-n₂₀, n₀₀-n₃₀, etc. If it is determined that repeated transmission of differential symbols is necessary to create a signal that is resistant to random phase errors, differential symbols may be transmitted repeatedly, such as n₀₇-n₁₇ and n₀₈-n₁₈.

In addition, as shown in FIG. 29, the first frame structure may include REs of a wide bandwidth and have the length of short symbols compared to the second frame structure. At this time, from the viewpoint of transmission/reception synchronization, the ratio between the length of the up-conversion symbols between CC or BWP and the length of the down-conversion symbols may be configured as shown in Equation 4.

$${α S}_{U} = {S}_{D} \qquad [ Equation 4 ]$$

$$or$$

$$\frac{1}{α} {S}_{U} = {S}_{D}$$

In Equation 4, S_{U} denotes the length of the up conversion symbol, S_{D} denotes the length of the down conversion symbol, and a denotes the coefficient representing the ratio between the symbol lengths. Here, the coefficient α is set to an arbitrary integer value and may be signaled through the upper layer, MAC-CE, or DCI.

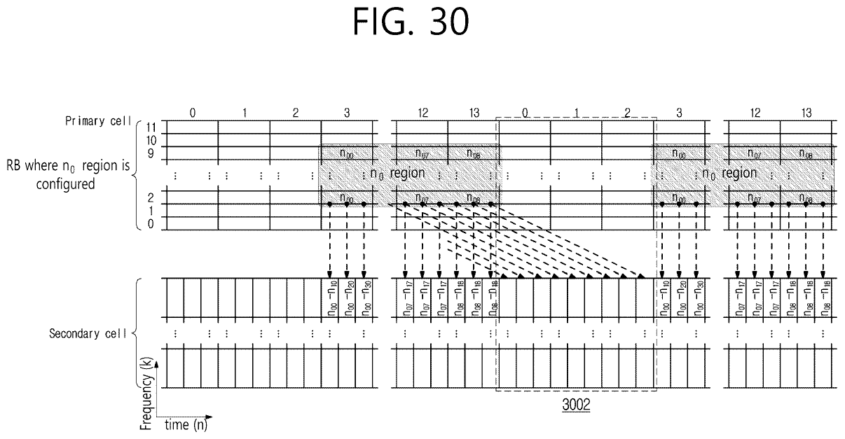

As described above, the initial symbol n₀ₓ for the DPSK scheme is mapped to the xth symbol in the n₀ region. However, if no OFDM symbol is allocated to the xth symbol in the n₀ region, the initial symbol mapped to the x-βth symbol may replace n₀ₓ. Here, the offset β is set to an arbitrary integer value and may be signaled through the upper layer, MAC-CE, or DCI. An example of applying the offset β is shown in FIG. 30.

FIG. 30 shows another example of mapping of initial symbols and differential symbols based on DPSK modulation according to an embodiment of the present disclosure. FIG. 30 shows an example where the offset β is set to 3. Referring to FIG. 30, the interval (3002) is not allocated for the n₀ region. Accordingly, if there are differential symbols transmitted through the secondary cell in the interval (3002), at least one initial symbol for the corresponding differential symbols may be replaced by initial symbols transmitted through OFDM symbols preceding by the offset β (=3).

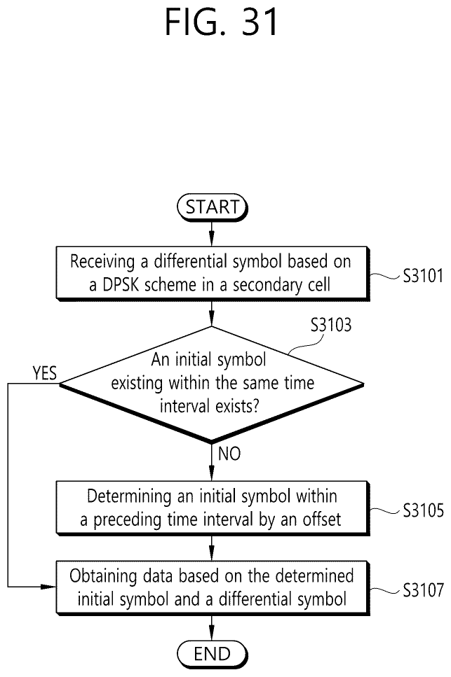

FIG. 31 shows an example of a procedure for mapping initial symbols and differential symbols received in different time intervals according to an embodiment of the present disclosure. FIG. 31 shows an example of a method performed by a second device that receives the symbols.

Referring to FIG. 31, in step S3101, the second device receives at least one differential symbol based on the DPSK scheme in the secondary cell. The second device may receive at least one differential symbol in the secondary cell configured as the first frame structure.

In step S3103, the second device determines whether an initial symbol exists in the same time interval. In order to obtain an initial symbol corresponding to at least one received differential symbol, the second device determines the same time interval in the primary cell configured with the second frame structure. Here, the same time interval means at least one OFDM symbol of the primary cell that overlaps at least partially with the resource to which at least one differential symbol is mapped in the time axis.

If no initial symbol exists in the same time interval, in step S3105, the second device determines the initial symbol in the time interval preceding by the offset. The value of the offset (e.g., β) may be signaled in advance. That is, since the initial symbol (e.g., n₀ₓ) that can be mapped to at least one received differential symbol (e.g., n₀ₓ-n₁ₓ) does not exist in the xth OFDM symbol within the n₀ region, the second device determines to use the initial symbol received at the x-βth OFDM symbol in the n₀ region as the initial symbol corresponding to at least one differential symbol received in step S3101.

In step S3107, the second device obtains data based on the determined initial symbol and at least one differential symbol. The second device may restore the data by demodulating and decoding the initial symbol and at least one differential symbol. For example, the second device may obtain a difference value from the differential symbol and the preceding symbol, and obtain data represented by the differential symbol by summing the value of the preceding symbol and the difference value.

According to the various embodiments described above, signals may be transmitted and received by using a hybrid transceiver that simultaneously uses an up-conversion numerology-based frame structure and a down-conversion numerology-based frame structure. When using a DPSK modulation scheme, data can be decoded based on differential symbols only if the initial symbol is transmitted correctly. Therefore, by selecting a method of repeatedly transmitting the initial symbol by using an up-conversion numerology-based frame structure, it is possible to design the system so that errors in the initial symbol are reduced. If the down-conversion numerology-based frame structure has a more robust nature against transmission errors, it is also possible to allocate the initial symbol and the differential symbol in the opposite manner. In other words, the initial symbol and the differential symbol do not necessarily have to be allocated in a specific manner.

As an example, in a frame structure such as FIG. 21c, a method of transmitting an initial symbol in the first secondary cell and transmitting a differential symbol in the second secondary cell may be implemented. Therefore, both the initial symbol and the differential symbol may be transmitted in the down conversion numerology frame structure. In this case, the method of mapping the differential symbols to the initial symbols may be implemented similarly to the method described above. For example, as described above, the ratio coefficient α between the differential symbols using DPSK and the initial symbols may be set, and when there are no synchronized initial symbols, the β value that can use the previous initial symbols may be set.

In addition, the first device and the second device may be configured to share an initial symbol. In this case, transmission of the initial symbol may be omitted. Therefore, the first device may always transmit differential symbols by using DPSK based on the same initial symbol. The second device may decode the received differential symbols based on the initial symbol shared with the first device.

The above-described proposal methods may be implemented independently, but may also be implemented as a combination (or merging) of some of the proposal methods. The rules may be defined such that the base station informs the UE via a predefined signal (e.g., physical layer signal or higher layer signal) whether any of the above proposed methods are applied (or information for the rules of the above proposed methods).

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. It will be obvious to those skilled in the art that claims that are not explicitly cited in each other in the appended claims may be presented in combination as an embodiment of the present disclosure or included as a new claim by a subsequent amendment after the application is filed.

### INDUSTRIAL APPLICABILITY

Embodiments of the present disclosure may be applied to various wireless access systems. Examples of various wireless access systems include, for example, 3rd Generation Partnership Project (3GPP) or 3GPP2 systems, etc.

Embodiments of the present disclosure may be applied not only to the various wireless access systems described above, but also to any technology field in which the various wireless access systems are applied. Further, the proposed methods may also be applied to mmWave, THz communication systems using ultra-high frequency bands.

Additionally, embodiments of the disclosure may be applied to various other applications, such as autonomous vehicles, drones, and the like.

1. A method comprising:
determining a configuration for a frame structure including at least one of at least one chunk, a first frequency gap between the at least one chunk, at least one sub-chunk included in the at least one chunk;
generating at least one first signal by down conversing at least one optical signal corresponding to the at least one chunk; and
transmitting the at least one first signal by using the at least one chunk mapped to a first frame, based on the configuration,
wherein a second frequency gap between the at least one sub-chunk is determined based on a phase noise.

2. The method of claim 1, wherein the at least one chunk is determined based on output bandwidth of an optical to electrical converter that down converses an optical signal.

3. The method of claim 1, further comprising:
generating a second signal by up conversing a low frequency band signal to a high frequency band; and
transmitting the second signal through a second frame that is based on orthogonal frequency division multiplexing (OFDM).

4. The method of claim 3, wherein the first signal is transmitted in at least one secondary cell,
wherein the second signal is transmitted in a primary cell.

5. The method of claim 3, wherein the first signal and the second signal are transmitted through the same frequency band.

6. The method of claim 5, wherein a time point at which the first frame and the second frame are mapped is determined based on a retuning time.

7. The method of claim 5, wherein a time point at which the first frame and the second frame are mapped is indicated based on a bitmap.

8. The method of claim 3, wherein the second signal includes at least one initial symbol,
wherein the first signal includes at least one differential symbol,
wherein the at least one differential symbol is generated based on differential phase shift keying (DPSK).

9. The method of claim 8, wherein the at least one initial symbol is modulated using a binary phase shift keying (BPSK) scheme or repeatedly transmitted.

10. The method of claim 8, wherein the at least one initial symbol is allocated to a specific region of a frame, a subframe, or a slot, through a location and a length of a start symbol.

11. The method of claim 8, further comprising:
determining a first region to map the at least one initial symbol; and
determining a second region to map the at least one differential symbol corresponding to the first region.

12. The method of claim 11, wherein a reference signal is transmitted preferentially over the initial symbol, when the reference signal is allocated in the first region.

13. The method of claim 11, wherein the at least one differential symbol is mapped to the at least one initial symbol that is present within the same time interval.

14. The method of claim 13, further comprising:
determining a number of the at least one differential symbol corresponding to the at least one initial symbol.

15. The method of claim 11, wherein the at least one differential symbol is mapped to the at least one initial symbol that is present before a pre-configured offset value, when the at least one initial symbol is not present within the same time interval as the at least one differential symbol.

16. A method performed by a second device in wireless communication system, the method comprising:
determining a configuration related to at least one chunk, a first frequency gap between the at least one chunk, and at least one sub-chunk included in the at least one chunk;
determining the at least one chunk mapped to a first frame based on the configuration; and
obtaining data based on at least one first signal received through the at least one chunk,
wherein a second frequency gap between the at least one sub-chunk is determined based on phase noise.

17. A first device comprising:
a transceiver; and
a processor connected to the transceiver,
wherein the processor controls the first device to:
determine a configuration for a frame structure including at least one of at least one chunk, a first frequency gap between the at least one chunk, at least one sub-chunk included in the at least one chunk;
generate at least one first signal by down conversing at least one optical signal corresponding to the at least one chunk; and
transmit the at least one first signal by using the at least one chunk mapped to a first frame, based on the configuration,
wherein a second frequency gap between the at least one sub-chunk is determined based on a phase noise.

18. (canceled)

19. (canceled)

20. (canceled)
